(19) United States
(12) Patent Application Publication
(10) Pub. No.: US 2025/0304797 A1
(43) Pub. Date: Oct. 2, 2025

(54) LOW TEMPERATURE CURABLE MULTILAYER COATING SYSTEMS WITH EXCELLENT APPEARANCE

(71) Applicant: BASF COATINGS GMBH, Muenster (DE)

(72) Inventors: Md Ershad MISTRI, Mangalore (IN); Donald H. CAMPBELL, Hartland, MI (US); Manoj KAYARKATTE, Mangalore (IN); Qingling ZHANG, Southfield, MI (US); Rajkumar JANA, Mangalore (IN); Ahammad ARIF, Mangalore (IN)

(21) Appl. No.: 18/863,866

(22) PCT Filed: Jun. 7, 2023
(86) PCT No.: PCT/EP23/65229

§ 371 Date: Nov. 7, 2024

(30) Foreign Application Priority Data
Jun. 9, 2022 (EP) 22178186.7

(51) Int. Cl. C09D 5/00; C09D 7/62; C09D 123/28; C09D 175/04

(52) U.S. Cl. CPC C09D 5/002; C09D 7/62; C09D 123/283; C09D 175/04

(57) ABSTRACT

Disclosed herein are a multilayer coating system present on a substrate including at least three layers L1 to L3, layer L1 being obtained from a primer coating composition, which is obtained from a primer coating system including at least two components A) and B) separated from each other, where component A) inter alia includes at least one constituent a2), which is at least one (meth)acrylic polymer, which has been modified with at least one chlorinated polyolefin, where the polymer contains functional groups, that are reactive towards NCO-groups, layer L2 being obtained from a basecoat composition, and layer L3 being obtained from a clearcoat composition, a method of preparing a multilayer coating system making use of the aforementioned primer coating system, and a kit-of-parts including separated from one another at least the primer coating system and a clearcoat composition or a clearcoat system.

The present invention relates to a multilayer coating system present on a substrate comprising at least three layers L1 to L3, layer L1 being obtained from a specific primer coating composition, layer L2 being obtained from a basecoat composition, and layer L3 being obtained from a clearcoat composition, a method of preparing a multilayer coating system making use of said specific primer coating composition, and a kit-of-parts comprising separated from one another at least a primer coating system suitable for preparing the specific primer coating composition and a clearcoat composition or a clearcoat system suitable for preparing a clearcoat composition.

### BACKGROUND OF THE INVENTION

In typical automotive coating processes, usually multiple layers are applied to the surface of a suitable substrate in form of a multilayer coating system. In particular, in case plastic or fiber reinforced plastic substrates are used, at least a primer, at least one basecoat, and a topcoat, in particular a clearcoat as outermost layer, are applied in this sequence. At least the basecoat and the topcoat are nowadays typically applied making use of a wet-on-wet-application. Afterwards the coated substrate is passed through an oven at temperatures to cure at least the basecoat(s) and the topcoat such as the clearcoat simultaneously in, e.g., a 2C1B process. In some cases, also the primer coat is cured at this stage together with the basecoat(s) and topcoat, in particular clearcoat, e.g., in a 3C1B process.

As demand for fuel efficient automobiles has increased, there is in particular a great interest in the use of lightweight materials for use as automotive parts, in particular for exterior body parts. For this reason, there is in particular a demand for using the aforementioned reinforced plastic and especially carbon fiber reinforced plastic (CFRP) substrates as substrates for preparing multilayer coating systems onto their surfaces as they are lightweight substrates.

In addition to this general advantage of using such lightweight substrates, there are usually quite a number of requirements necessary, which have to be fulfilled and/or met by the single layers present within the multilayer coating system on these substrates, but also on other substrates, used in the automotive industry and by the multilayer coating systems as such due to regulations, but also due to quality standards set by the automotive industry. Thus, the multilayer coatings have to exhibit or display a number of desired characteristics to at least a sufficient extent in order to meet these requirements. In particular, exterior body parts of an automobile must have an excellent paint finish, which is often referred to as “class-A appearance” within the automotive industry.

When conventional multilayer coating systems are applied particularly on top of fiber reinforced substrates such as CFRP substrates, often an undesired unevenness, i.e., a paint defect, of the accordingly coated substrate is observed after the baking step once the coated substrate is cooled down. This unevenness may propagate to the top layer of the multilayer coating system applied on the substrate such as the CFRP substrate and may then spoil the paint finish. This undesired defect is known as telegraphing effect. The telegraphing occurs mainly due to a comparably low glass transition temperature (T_{g}) of the plastic substrate and differences in the coefficients of thermal expansion (CTE) between the plastic substrate and the reinforced fibers present therein, which are usually glass fibers and/or carbon fibers. However, an observed undesired surface unevenness may not only be the mere result of the aforementioned telegraphing effects due to the (fiber reinforced) plastic substrates used, but may additionally or even alternatively occur due to undesired telegraphing effects of the interface between the coating layers of the multilayer coating systems used also on different kinds of substrates.

Thus, there is a need to provide new multilayer coating systems on substrates, in particular on plastic substrates including reinforced plastic substrates such as CFRP, which do not show any undesired telegraphing effects or at least show lesser telegraphing effects than observed for conventional multilayer coating systems, i.e., which display an excellent paint finish (“class-A appearance”), but which at the same time additionally also do not show any disadvantages as far as other relevant properties of the multilayer coating systems are concerned such as in particular packaging stability.

### Problem

It has been therefore an objective underlying the present invention to provide multilayer coating systems on substrates, in particular on plastic substrates including reinforced plastic substrates such as CFRP, which do not show any undesired telegraphing effects or at least show less telegraphing effects than observed for conventional multilayer coating systems, hence which display an excellent paint finish (“class-A appearance”), but which at the same time additionally also do not show any disadvantages as far as other relevant (critical) properties of the multilayer coating systems are concerned such as in particular packaging stability.

### Solution

This objective has been solved by the subject-matter of the claims of the present application as well as by the preferred embodiments thereof disclosed in this specification, i.e., by the subject matter described herein.

A first subject-matter of the present invention is a multilayer coating system being present on an optionally pre-coated substrate and comprising at least three coatings layers L1, L2 and L3 being different from one another, namely
a first coating layer L1 applied over at least a portion of an optionally pre-coated substrate, said layer L1 being obtainable from a primer coating composition, which in turn is obtainable from a primer coating system comprising at least two components A) and B) and optionally at least one further component C), said components being different from one another and being separate from each other,
wherein component A) comprises at least constituent a2) and optionally at least constituent a1), which are different from one another, namely
   optionally at least one organic solvent a1), and
   at least one polymer a2), which contains functional groups, that are reactive towards NCO-groups, wherein polymer a2) is a (meth)acrylic polymer, which has been modified with at least one chlorinated polyolefin,
wherein component B) comprises at least two constituent b2) and optionally at least constituent b1), which are different from one another, namely
   optionally at least one organic solvent b1), and
   at least one organic constituent b2) bearing on average two or more NCO-groups, and
wherein optional component C) is a reducer component and comprises at least one organic solvent c1),
a second coating layer L2 applied over the first coating layer L1, said layer L2 being obtainable from a basecoat composition, and
a third coating layer L3 applied over the second coating layer L2, said layer L3 being obtainable from a clearcoat composition,
preferably wherein layer L3 is obtainable from a 2K-clearcoat composition, which in turn is obtainable from a clearcoat system comprising at least two components D) and E) and optionally at least one further component F), said components being different from one another and being separate from each other,
wherein component D) comprises at least constituent d2) and optionally at least constituent d1), which are different from one another, namely
   optionally at least one organic solvent d1), and
   at least one OH-functional (meth)acrylic polymer d2),
wherein component E) comprises at least constituent e2) and optionally at least constituent e1), which are different from one another, namely
   optionally at least one organic solvent e1), and
   at least one organic constituent e2) bearing on average two or more NCO-groups, wherein at least a part of these NCO-groups has been reacted with at least one organosilane prior to incorporation of constituent e2) into component E), and
wherein optional component F) is a reducer component and comprises at least one organic solvent f1).

A further subject-matter of the present invention is a use of the multilayer coating system as defined hereinbefore and hereinafter comprising at least three coatings layers L1, L2 and L3 being different from one another for application on substrates selected from metal and plastic substrates, preferably selected from plastic substrates, more preferably selected from fiber reinforced plastic substrates, even more preferably selected from carbon fiber reinforced plastic substrates.

A further subject-matter of the present invention is a method of preparing a multilayer coating system on at least one surface of an optionally pre-coated substrate comprising at least steps 1) to 3) and optionally 4), namely
1) applying a first coating composition at least partially to at least one surface of an optionally pre-coated substrate and forming a first coating film on said surface,
   wherein the first coating composition is an inventively used primer coating composition as defined hereinbefore and hereinafter,
2) applying at least one basecoat composition as at least one second coating composition to the first coating film present on the substrate obtained after step 1), preferably prior to curing the first coating film, and forming a second coating film, which is preferably adjacent to the first coating film, and
3) applying a clearcoat composition as third coating composition to the second coating film present on the substrate obtained after step 2), preferably prior to curing the second coating film and forming a third coating film, which is preferably adjacent to the second coating film and which preferably is the outermost coating film of the formed multilayer coating system, wherein the third coating composition preferably is an inventively used clearcoat composition as defined hereinbefore and hereinafter,
4) optionally jointly curing the first, second and third coating films to obtain a multilayer coating system comprising cured first, second, and third coating layers, preferably at a temperature not exceeding 80° C., more preferably not exceeding 70° C., still more preferably not exceeding 60° C., even more preferably not exceeding 55° C., in particular, when a plastic substrate or fiber reinforced plastic substrate is used as optionally pre-coated substrate.

A further subject-matter of the present invention is a kit-of-parts comprising separated from one another at least
an inventively used primer coating system as defined hereinbefore and hereinafter comprising the at least two components A) and B) and optionally at least one further component C) and
a clearcoat composition, preferably a 1K-clearcoat composition, or a 2K-clearcoat system suitable for preparing a clearcoat composition, preferably comprising at least two components D) and E) and optionally at least one further component F) as defined hereinafter and hereinbefore.

It has been in particular surprisingly found that that an excellent paint finish (“class-A appearance”) of in particular LW (long wave) values≤10 and short wave (SW) values≤20 is achieved for the inventive multilayer coating systems present on a substrate, in particular on a plastic substrates such as TPO (thermoplastic polyolefins) as well as (carbon) fiber reinforced plastic substrates including carbon fiber reinforced polyamides, where the multilayer coating system comprises a primer layer derived from a primer film, which has been obtained from an inventively used 2K-primer coating composition. Moreover, it has been further surprisingly found that this effect can be observed for multiple different kinds of other substrates such as metal substrates as well and also is independent of the nature of the basecoat materials (solventborne and waterborne basecoats) used as intermediate coats (basecoats) for preparing the multilayer coating systems.

It has been found that the aforementioned advantages are particularly observed when the inventive multilayer coating systems are prepared in a 3C1B-method, wherein primer, basecoat and clearcoat films are cured simultaneously. Such a method has the further advantage of a lower process time and the need of performing only one single baking step, which is both economically and ecologically advantageous.

Further, it has been found that the multilayer coating system can be obtained by curing (baking) at low temperature as low as 50° C., which is energy efficient and eco-friendly, and is particularly advantageous when the substrates used are plastic substrates, in particular carbon fiber reinforced plastic substrates

Further, it has been in particular surprisingly found that the aforementioned excellent paint finish is not achieved in case of multilayer coating systems present on a substrate in combination with achievement of other required relevant properties, when (i) commercial (modified) 1K-primer coating formulations are comparatively used instead of an inventively used primer coating composition (cf. comparative examples CE1 and CE5 disclosed in the experimental part), (ii) a comparatively used 2K primer formulation not containing a constituent a2) has been used instead of an inventively used primer coating composition (cf. comparative example CE2 disclosed in the experimental part), and (iii) different comparatively used 2K clearcoat formulations have been used instead of an inventively used primer coating composition (cf. comparative examples CE3 and CE4 disclosed in the experimental part). In case of each of CE2, CE3, CE4 and CE5 SW values too high were observed in order to be able to meet the “class A requirements” regarding appearance. CE2 and CE4 also showed LW values too high. The “class A requirements” were met in case of CE1, but CE1 showed—similar to each of CE2 to CE5—inferior other required relevant properties, namely inferior tape adhesion after humidity exposure, non-sufficient steam jet and non-sufficient thermal shock properties.

It has been additionally found that an inventively prepared primer coating film obtained from an inventively used primer coating composition has an ability to at least partially also cure a basecoat film applied on top of said primer coating film even at temperatures as low as 50° C. due to isocyanate migration from the primer film into the basecoat film, especially when the primer coating composition used contains an excess of constituent b2) bearing on average two or more NCO-groups such that upon migration of said constituent into the aforementioned basecoat film, applied on top of a primer coating film obtained from the primer coating composition onto a substrate, at least partial curing of the basecoat film is achieved, when said film contains at least one preferably polymeric constituent, which contains functional groups that are reactive towards the NCO-groups of constituent b2).

### DETAILED DESCRIPTION OF THE INVENTION

The term “comprising” in the sense of the present invention, in connection for example with the primer coating composition, the clearcoat composition, or one of the components of a primer coating or clearcoat system, preferably has the meaning of “consisting of”. With regard, e.g., to the primer coating composition, the clearcoat composition, or one of the components of the primer coating or clearcoat system it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the coating compositions such as the primer coating composition or the clearcoat composition add up to 100 wt.-%, based in each case on the total weight of the respective coating composition. The same applies in relation to each component of a coating system such as components A) or B) of the primer coating system or components D) and E) of the clearcoat system: The proportions and amounts in wt.-% (% by weight) of any of the constituents given hereinafter, which are present in one of these components add up to 100 wt.-%, based in each case on the total weight of the respective component.

### Multilayer Coating System

### Layers L1, L2, L3 and Substrate

A first subject-matter of the present invention is a multilayer coating system being present on an optionally pre-coated substrate and comprising at least three coating layers L1, L2 and L3 being different from one another.

Preferably, the at least three coatings layers L1, L2 and L3 are being positioned adjacently to each other. Preferably, the third coating layer L3 is the outermost coating layer of the multilayer coating system.

Preferably, the multilayer coating system is obtained by the inventive method of preparing a multilayer coating system, which will be described in detail hereinafter.

Each of layers L1, L2 and L3 represents a cured coating film. The first layer L1 is obtainable from the first coating film, the second layer L2 from the second coating film and the third layer L3 from the third coating film. The first coating film is a primer coating film, the second coating film is a basecoat film and the third coating film a clearcoat film. The term “primer” is known to a person skilled in the art. A primer typically is applied after the substrate has been provided with a cured electrodeposition coating layer in case of metallic substrates. In this case, the cured electrodeposition coating film is present underneath and preferably adjacent to the primer coating film. This is an example of a pre-coated substrate. In case of non-metallic substrates such as plastic substrates including fiber reinforced plastic substrates the primer coating film typically represents the first coating film applied onto their surfaces. The term “basecoat” is known to a person skilled in the art as well and, for example, defined in Römpp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition. This is generally applied to a metal or plastic substrate, in each case being optionally pre-coated. In order to protect a basecoat film in particular against environmental influences, at least one additional clearcoat film is applied to it. The term “clear coat”, “clearcoat” or “clear coating” is also known to a person skilled in the art and represents a transparent outermost layer of a multilayer coating structure applied to a substrate.

Preferably, the cured primer film (layer L1), preferably obtained after having performed step 4) of the inventive method of preparing a multilayer coating system, has a dry film thickness in a range of from 10 to 35 μm. Preferably, the cured basecoat film (layer L2), preferably obtained after having performed step 4) of the inventive method of preparing a multilayer coating system, has a dry film thickness in a range of from 12 to 35 μm. Preferably, the cured clearcoat film (layer L3), preferably obtained after having performed step 4) of the inventive method of preparing a multilayer coating system, has a dry film thickness in a range of from 30 to 60 μm.

The substrate can be an automotive vehicle body or a part thereof. The substrate can be a metallic substrate, but also plastic substrates such as polymeric substrates and fiber reinforced plastic substrates can be used.

Suitable as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production. A metallic substrate may have been pretreated with at least one metal phosphate such as zinc phosphate and/or pretreated with at least one an oxalate. A pretreatment of this kind by means of phosphating or oxalating, which takes place normally after the substrate has been cleaned and before the substrate is electrodeposition-coated, is in particular a pretreatment step that is customary in the automobile industry. The metallic substrate may further comprise a cured electrodeposition coating layer as pre-coat.

Preferably, thermoplastic polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

Further, and most preferred, fiber reinforced plastic substrates are used. Glass and/or carbon fibers can be in particular used for reinforcement, most preferably carbon fibers. An examples of a suitable carbon fiber reinforced plastic substrate is a carbon fiber reinforced polyamide substrate. As outlined above, most preferred, the substrate is a plastic substrate, more preferably a fiber reinforced plastic substrate, more preferably a carbon fiber reinforced plastic substrate.

### Primer Coating Composition

The first coating layer L1 is applied over at least a portion of an optionally pre-coated substrate, said layer L1 being obtainable from a primer coating composition, which in turn is obtainable from a primer coating system comprising at least two components A) and B) and optionally at least one further component C), said components being different from one another and being separate from each other. The preparation of the primer coating composition can be carried out using customary and known preparation and mixing methods and mixing units, or using conventional dissolvers and/or stirrers.

Preferably, the primer coating composition is a solventborne, i.e., an organic solvent(s) based, coating composition, preferably due to the presence of constituents a1) and b1) and optionally c1). The term “solventborne” in connection with the coating composition is understood preferably for the purposes of the present invention to mean that the aforementioned organic solvent(s), as solvent and/or as diluent, is/are present as the main constituent(s) of all solvents and/or diluents present therein, preferably in an amount of at least 35 wt.-%, based on the total weight of the coating composition. Thus, preferably, the coating composition is not a waterborne, i.e., not an aqueous, coating composition.

The primer coating composition preferably includes an organic solvent(s) fraction of at most 75 wt.-%, more preferably of at most 70 wt.-%, even more preferably of at most 65 wt.-%, still more preferably of at most 60 wt.-%, based in each case on the total weight of the coating composition. All conventional organic solvents known to those skilled in the art can be used as organic solvents, i.e., as constituents a1) and b1) and optionally c1). The term “organic solvent” is known to those skilled in the art, in particular from Council Directive 1999/13/EC of 11 Mar. 1999. Examples of the organic solvents which can be used have been mentioned hereinbefore in connection with constituents a1) and b1) and c1). Preferably, the primer coating composition includes an organic solvent(s) fraction in a range of from 30 to 70 wt.-%, based on the total weight of the coating composition.

Preferably, the primer coating composition has a total solids content, which is >25 wt.-%, more preferably >30 wt.-%, even more preferably >35 wt.-%, based in each case on the total weight of the coating composition.

The total solids content of the primer coating composition is preferably in a range of from >20 to 60 wt.-%, more preferably of from >25 to 55 wt.-%, even more preferably of from >30 to 50 wt.-%, still more preferably of from >30 to 45 wt.-%, based in each case on the total weight of the coating composition. The total solids content, in other words the non-volatile fraction, is determined in accordance with the method described hereinafter.

Preferably, the primer coating composition is obtainable by mixing components A) and B) in a weight ratio (component A)/component B)) in a range of from 25:1 to 1:1. More preferably, mixing is performed in a weight ratio in the range of from 20:1 to 1.1:1, even more preferably in a weight ratio in the range of from 17.5:1 to 2:1, in particular in a weight ratio in the range of from 15:1 to 3:1.

Preferably, the primer coating composition contains an excess of constituent b2) bearing on average two or more NCO-groups such that upon migration of said constituent into an intermediate coating film, preferably into a basecoat film, applied on top of a primer coating film obtained from the primer coating composition onto a substrate, at least partial curing of the intermediate coating film is achieved, when said intermediate coating film contains at least one preferably polymeric constituent, which contains functional groups that are reactive towards NCO-groups. The term “excess” in this context preferably means a molar or mass excess, more preferably a mass excess.

The term “excess of constituent b2)” preferably means that an amount of 5 to 20 wt.-%, preferably 7.5 to 15 wt.-%, more preferably 10 to 12.5 wt.-% to of constituent b2) originating from component “B”, in each case based on the total weight of constituent b2) originally present in said component B), is still present in the resulting primer coating composition after mixing, which amount is not used for crosslinking with the relevant constituents such as constituent a2) of component A) due to using constituent b) in a super-stoichiometric amount. By this it is possible to also at least partially cure a subsequently to be applied basecoat film via NCO-migration when applied on top of a primer coating film being obtainable from applying the primer coating material composition onto a surface of a substrate.

### Primer Coating System

The primer coating system used for preparing the primer coating composition is a two- (2K-) or multi-component coating system. Separate from each other in this context means that components A) and B) and optionally C) of the coating system can be stored separately until they are mixed with each other in order to prepare a primer coating composition. In case the coating system is a two-component coating system, it preferably consists of components A) and B). Upon mixing of at least the two components A) and B) and applying the resulting composition to a surface of a substrate, a polyurethane or polyurethane-based coating film is preferably formed at least by reaction of the functional groups such as OH-groups of the at least one constituent a2) with the isocyanate groups of the at least one constituent b2).

Preferably, both components A) and B) and also optional component C) of the coating system are free or essentially free of water. The same applies to the coating compositions obtainable therefrom. In the sense of the present invention the term “free of water” preferably means that no water at all is present. In the sense of the present invention the term “essentially free of water” preferably means that essentially no water is present. This means that at least no water is added on purpose to any of the inventively used components A) and B) and optionally C) and to the coating composition obtainable therefrom. It may, however, not be ruled out that remaining residues of water formed upon preparation of any of the constituents used for preparing the inventively used components A) and B) and optionally (C) are present therein. Preferably, the amount of any water present in each of the component A) and B) and optionally C) is less than 1 wt.-%, more preferably less than 0.5 wt.-%, even more preferably less than 0.1 wt.-%, still more preferably less than 0.05 wt.-%, yet more preferably less than 0.01 wt.-%, in particular less than 0.005 wt.-% or less than 0.001 wt.-%, in each case based on the total weight of component A) or B) or optionally C). Preferably, both components A) and B) and also optional component C) of the coating system are solventborne, i.e., organic solvent(s)-based. Thus, preferably, the coating system is not a waterborne, i.e., not an aqueous coating system.

### Component A)

Component A) comprises at least constituent a2) and optionally at least one constituent a1), which are different from one another, but may additionally comprise further optional constituents such as constituents a3), a4), a4a), a5), a6), a7), a8), a9) and/or a10). All constituents present are different from one another.

Preferably, component A) of the primer coating system has a total solids content, which is >20 wt.-%, preferably >25 wt.-%, more preferably >30 wt.-%, even more preferably >45 wt.-%, based on the total weight of component (A). The total solids content of component A) of the primer coating system is preferably in a range of from >20 to 60 wt.-%, more preferably of from 25 to 50 wt.-%, even more preferably of from 30 to 45 wt.-%, based in each case on the total weight of component A). The total solids content, in other words the non-volatile fraction, is determined in accordance with the method described hereinafter.

### Optional Constituent a1)

Optional constituent a1) is at least one organic solvent. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. Component A) may comprise more than one organic solvent a1).

Preferably, the amount of optional constituent a1) in component (A) is in the range of from 0 to 80 wt.-% or of from 10 to 80 wt.-%, more preferably of from 25 to 75 wt.-%, even more preferably of from 40 to 70 wt.-%, based in each case on the total weight of component A).

### Constituent a2)

Constituent a2) is at least one (meth)acrylic polymer, which has been modified with at least one chlorinated polyolefin, and which contains functional groups, that are reactive towards NCO-groups such as OH-groups, thiol groups, carbamate groups, COOH-groups and/or amino groups. Preferably, constituent a2) is an OH-functional polymer. Constituent a2) such as an OH-functional polymer preferably functions as film-forming binder. For the purposes of the present invention, the term “binder” is understood in accordance with DIN EN ISO 4618 (German version, date: March 2007) to be the non-volatile constituent of a coating composition, which is responsible for the film formation. Pigments and/or fillers contained therein are thus not subsumed under the term “binder”. Preferably, constituent a2) represents the main binder. As the main binder in the sense of the present invention, a binder constituent is preferably referred to, when there is no other binder constituent in the coating composition or a component used for its preparation, which is present in a higher proportion based on the total weight of the coating composition or component.

The term “polymer” is known to the person skilled in the art and, for the purposes of the present invention, encompasses polyadducts and polymerizates as well as polycondensates. The term “polymer” includes both homopolymers and copolymers.

If constituent a2) is at least one OH-functional polymer, it preferably comprises on average two or more OH-groups.

Preferably, constituent a2) is at least one OH-functional (meth)acrylic polymer, which has been modified with at least one chlorinated polyolefin. “Modified” preferably means that a chlorinated polyolefin is covalently linked to the (meth)acrylic polymer. It is possible that that the chlorinated polyolefin is connected to the backbone (main chain) of the (meth)acrylic polymer and/or to at least one side chain thereof. An example of such a polymer is Acrydic® CL-408.

Preferably, component A) of the primer coating system comprises the at least one constituent a2) in an amount in a range of from 5.0 to 50.0 wt.-%, more preferably of from 10.0 to 45.0 wt.-%, even more preferably of from 15.0 to 40.0 wt.-%, still more preferably of from 17.5 to 35.0 wt.-%, in each case based on the total weight of component A).

Optional Catalyst Constituents a3), a4) and/or a4a)

Optionally, at least one of catalyst constituents a3), a4) and a4a) may be present in component A) of the primer coating system.

The at least one optionally present catalyst a3) is suitable for crosslinking of NCO-groups and is preferably selected from organotin catalysts. Preferably, the at least one catalyst a3) is suitable for crosslinking of NCO-groups of the constituent b2) of component B).

Preferably, component A) of the primer coating system comprises the at least one catalyst a3) in an amount in a range of from 0.001 to 1.00 wt.-%, more preferably of from 0.002 to 0.80 wt.-%, even more preferably of from 0.003 to 0.60 wt.-%, still more preferably of from 0.004 to 0.40 wt.-%, yet more preferably of from 0.005 to 0.20 wt.-%, most preferably of from 0.007 to 0.15 wt.-%, in each case based on the total weight of component A).

Catalyst a3) preferably is selected from organometal catalysts and is more preferably selected from organotin catalysts. Examples of organotin catalysts are DOTL (dioctyltin dilaurate) and DBTL (dibutyltin dilaurate). DOTL is particularly preferred.

The at least one optionally present catalyst a4) is selected from phosphorus-containing organic constituents, which are not blocked with any amine, and is preferably suitable for crosslinking of Si-containing functional groups, in particular being present in constituent b3) of component B), if constituent b3) is present.

Preferably, component A) of the primer coating system comprises the at least one catalyst a4) in an amount in a range of from 0.01 to 1.0 wt.-%, more preferably of from 0.02 to 0.8 wt.-%, even more preferably of from 0.03 to 0.6 wt.-%, still more preferably of from 0.04 to 0.5 wt.-%, yet more preferably of from 0.05 to 0.4 wt.-%, in each case based on the total weight of component A).

In particular, the at least one catalyst a4), which is a phosphorus-containing catalyst, is a catalyst, which does not contain any nitrogen. More than one such as two different catalysts can be used as catalyst a4).

Examples of suitable phosphorus-containing catalysts for use as catalysts a4) are substituted phosphonic diesters and diphosphonic diesters, preferably selected from the group consisting of acyclic phosphonic diesters, cyclic phosphonic diesters, acyclic diphosphonic diesters and cyclic diphosphonic diesters. More particularly, however, use as at least one catalyst a4) is made of substituted phosphoric monoesters and phosphoric diesters, preferably selected from the group consisting of acyclic phosphoric diesters and monoesters and cyclic phosphoric diesters and monoesters. All these esters cannot be present in the form of amine adducts, since catalyst a4) is not blocked with any amine.

Preferably, at least 2-ethylhexylacid phosphate is used as at least one catalyst a4). The term “2-ethylhexylacid phosphate” comprises both monoethylhexyl acid phosphate and diethylhexyl acid phosphate.

Catalyst a4), being a phosphorus-containing organic constituent, which is not blocked with at least one amine, can be and preferably is used in combination with at least one phosphorus-containing organic constituent as at least one catalyst a4a), which is blocked with at least one amine, i.e., which is also nitrogen-containing. However, it is also possible that only a catalyst a4a) can be used and be present in component A), without necessarily also using a catalyst a4).

Preferably, component A) of the primer coating system comprises the at least one optionally present catalyst a4a) in an amount in a range of from 0.05 to 2.0 wt.-%, more preferably of from 0.06 to 1.8 wt.-%, even more preferably of from 0.07 to 1.6 wt.-%, still more preferably of from 0.08 to 1.4 wt.-%, yet more preferably of from 0.09 to 1.2 wt.-%, particularly preferred of from 0.10 to 1.0 wt.-%, in each case based on the total weight of component A).

Preferably, the amount of the catalyst a4a) (if present) exceeds the amount of the catalyst a4). Preferably, the relative weight ratio of catalysts a4) and a4a) to each other within component A) is in a range of from 0.1 to 1.0 to 0.9:1.0, more preferably of from 0.2 to 1.0 to 0.8 to 1.0, even more preferably of from 0.3 to 1.0 to 0.7 to 1.0.

Preferably, at least one catalyst a4) such as 2-ethylhexylacid phosphate is present in an amount in a range of from 0.01 to 0.4 wt.-%, and at least one catalyst a4a) is present in an amount in a range of from 0.05 to 1.0 wt.-%.

Preferably, the at least one catalyst a4a) is selected from phosphorus-containing organic constituents, more preferably from acyclic phosphoric diesters, acyclic phosphoric monoesters, cyclic phosphoric diesters and cyclic phosphoric monoesters, wherein each of the aforementioned phosphoric diesters and monoesters is present in form of an adduct with at least one amine (i.e., blocked with at least one amine), preferably, at least one tertiary amine.

Optional Constituent a5)—Condensation Product

Optionally and preferably, component A) of the primer coating system further comprises at least one constituent a5) being different from any of constituents a1) to a4) and a4a), which is a condensation product, which in turn is obtainable at least by reaction of (i) at least one organosilane bearing at least one hydrolyzable group with (ii) at least one kind of silica. Condensation product a5) is herein also referred to as “condensate”.

Preferably, molar ratio of the at least one organosilane and the at least one kind of silica used for preparing condensation product a5) to each other is in a range of from 10:1 to 1:1, more preferably of from 8:1 to 1:1, even more preferably of from 6:1 to 1:1, yet more preferably of from 4:1 to 1:1, still more preferably of from 4:1 to 1.1:1, yet more preferably of from 4:1 to 1.5:1, most preferably of from 4:1 to 2:1.

Preferably, the at least one condensation product a5) is present in component A) in an amount in a range of from 1.0 to 25.0 wt.-%, more preferably of from 2.0 to 20.0 wt.-%, even more preferably of from 3.0 to 17.5 wt.-%, yet more preferably of from 4.0 to 15.0 wt.-%, still more preferably of from 5.0 to 14.0 wt.-%, even more preferably of from 6.0 to 13.0 wt.-%, most preferably of from 7.0 to 12.0 wt.-%, in each case based on the total weight of component A).

Preferably, condensation product a5) has an average particle size in a range of from 10 to 100 nm, more preferably of from 15 to 80 nm, even more preferably of from 20 to 70 nm, yet more preferably of from 25 to 60 nm, still more preferably of from 30 to 50, most preferably of from 35 to 45 nm, in each case measured by DLS (dynamic light scattering). The DLS method used is hereinafter specified in the ‘methods’ section. Preferably, the average particle size is measured at a high shear viscosity of 5 to 15 cP by using a CAP 2000 viscometer.

The term “silica” used in this context is a clear term for a person skilled in the art and refers to SiO₂. Preferably, the at least one kind of silica used is used in form of a basic or acidic, preferably basic, aqueous dispersion of preferably colloidal silica particles. Preferably, the silica particles have an average particle size of the silica ranging from 5 to about 300 nm, more preferably from 5 to 200 nm, even more preferably from 7.5 to 100 nm, still more preferably of from 7.5 to 50 nm, most preferably from 10 to 30 nm. The average particle size is measured via DLS. The DLS method being used is hereinafter specified in the ‘methods’ section and is the same method, which is also used for determining the average particle size of condensation product a5).

As outlined hereinbefore, both acidic and basic colloidal silica dispersions can be used. Colloidal silica dispersions having a low alkali content are, however, preferred.

Commercially available silica products, which can be used include, for example, Ludox® (Sigma Aldrich), Snowtex® (Nissan Chemical), Bindzil® (AkzoNobel), Nalco® Colloidal Silica (Nalco Chemical Company), and Levasil® (AkzoNobel) products. Particularly preferred colloidal silica products that can be used include Nalco® 1034A (Nalco Chemical Company), Snowtex® 040, Snowtex ST-033 and Snowtex® OL-40 (Nissan Chemical), Ludox®AS40 and Ludox®HS 40 (Sigma-Aldrich), Levasil 200/30 and Levasil® 200 S/30 (now Levasil CS30-516P) (AkzoNobel) and Cab-OSperse® A205 (Cabot Corporation) etc.

The at least one organosilane bearing at least one hydrolyzable group may optionally comprise and preferably comprises at least one non-hydrolyzable group, which preferably is an organic, preferably aliphatic, residue having 1 to 10 carbon atoms, which optionally further comprises at least one functional group.

Preferably, the at least one organosilane bearing at least one hydrolyzable group is a monosilane and has at least two, particularly preferably at least three hydrolyzable groups X, and/or is at least one bis(silane), which preferably has at least four, particularly preferably six hydrolyzable groups X. It is, however, also possible to employ monosilanes with four hydrolyzable groups X, i.e., monosilanes not containing any non-hydrolyzable residues, such as tetramethoxysilane and/or tetraethoxysilane.

Preferably, the at least one organosilane bearing at least one hydrolyzable group is an organosilane of general formula (1) and/or (2)

Si(X)_{4-y}(R)_{y}, (1),

Si(X)_{3-z}(T)_{z}-(RA)-Si(X)_{3-z}(T)_{z} (2),
wherein in the case of general formula (1)
X is each independently a hydrolyzable group, preferably each independently selected from O—C₁₋₄ alkyl,
the parameter y is 0 or an integer in the range from 1 to 3, preferably is at least 1, preferably exactly 1, and
R is a non-hydrolyzable organic residue, preferably aliphatic residue, which preferably has 1 to 10 carbon atoms, wherein at least one of residues R optionally comprises at least one functional group,
and wherein in the case of general formula (2)
X represents, in each case independently of one another, a hydrolyzable group and is preferably selected, in each case independently of one another, from O—C1-4-alkyl, RA represents a divalent non-hydrolyzable organic residue, preferably aliphatic residue, which preferably has 1 to 10 carbon atoms, which preferably contains no functional group,
the parameter z is in each case 0 or an integer in the range from 1 to 3, preferably in each case 0 or 1, more preferably in each case 1, and
T is a non-hydrolyzable organic residue, preferably aliphatic residue, which preferably has 1 to 10 carbon atoms, which is different from the residue RA, and which optionally comprises at least one functional group.

Examples of suitable functional groups are in particular thiol groups, amino groups, epoxide groups, in particular glycidoxy, epoxycyclohexyl and/or epoxycyclohexylethyl, OH-groups that are protected via a suitable protecting group, (meth)acrylate groups, vinyl groups, allyl groups, (meth)acryloxy groups, episulfide groups, ureido groups, thioureido groups, ether groups, thioether groups, sulfide groups, in particular disulfide trisulfide, tetrasulfide, pentasulfide, hexasulfide and/or polysulfide groups, xanthate groups, trithiocarbonate groups, dithiocarbonate groups, isocyanurato groups, and/or —Si(OR)₃ group wherein R₃ is an aliphatic residue, which preferably has 1 to 10 carbon atoms.

Examples of suitable organosilanes bearing at least one non-hydrozable group are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane, (3-glycidyloxypropyl)triethoxysilane, bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine, bis(4-butyltriethoxysilyl)amine, methyl trimethoxysilane, methyl triethoxysilane, ethyl trimethoxysilane, ethyl triethoxysilane, propyl trimethoxysilane, and/or propyl triethoxysilane.

Preferably, the condensation reaction of the at least one organosilane bearing at least one hydrolyzable group with the at least one kind of silica takes place in aqueous medium and preferably is catalyzed by at least one preferably organic acid.

Preferably, the at least one kind of silica is added to the at least one organosilane in the presence of water, preferably of 0.5-2.0 moles of water, based on the molar amount of the at least one organosilane, and in the presence of a preferably catalytic amount of at least one acid, more preferably of at least one organic acid such as acetic acid. The addition preferably takes place at a temperature between 0 and 10° C. After stirring of the resulting mixture, preferably at room temperature (18 to 23° C.) for 10 to 18 hours, preferably a further catalytic amount of at least one acid, more preferably of at least one organic acid such as acetic acid acetic acid and at least one ammonium salt such as tetrabutylammonium acetate (TBAA) as additional catalyst is added. Then, the resulting mixture is preferably stirred for 1 to 10 hours. Preferably, the pH value of the mixture is maintained at pH 3 to 6. Then, the resulting mixture preferably is diluted with, e.g., in a 1:1 weight ratio, with at least one organic solvent, which is miscible with water such as isopropanol (IPA).

The preparation of an exemplary condensation product a5) prepared from methyltrimethoxysilane (MTMS) as organosilane is outlined in the scheme below:

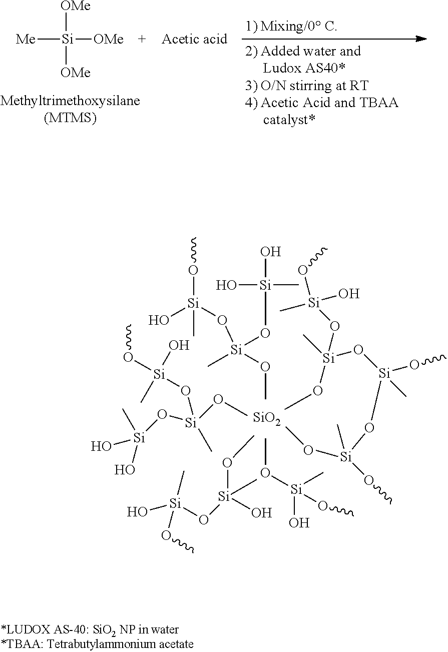

Preferably, the at least one condensation product a5) is present in the primer coating composition in an amount in a range of from 1.0 to 25.0 wt.-%, more preferably of from 2.0 to 20.0 wt.-%, even more preferably of from 3.0 to 17.5 wt.-%, yet more preferably of from 4.0 to 15.0 wt.-%, still more preferably of from 5.0 to 14.0 wt.-%, even more preferably of from 6.0 to 13.0 wt.-%, most preferably of from 7.0 to 12.0 wt.-%, based on the total weight of the primer coating composition.

### Further Constituents

Component A) of the primer coating system can optionally comprise one or more further constituents such as one or more of constituents a6) to a10), which are different from one another, different from each of constituents a1) to a3) and different from each of optional constituents a4), a4a) and a5). Preferably, component A) of the primer coating system comprises at least one, preferably at least two, more preferably at least three, of the constituents a6) to a8).

Preferably, component A) of the primer coating system comprises
at least one epoxy resin as constituent a6), preferably in an amount in a range of from 0.5 to 15.0 wt.-%, more preferably of from 1.0 to 10.0 wt.-%, even more preferably of from 1.5 to 7.5 wt.-%, still more preferably of from 2.0 to 5.5 wt.-%, in each case based on the total weight of component A),
and/or
at least one chlorinated polyolefin as constituent a7), preferably in an amount in a range of from 5.0 to 35 wt.-%, more preferably of from 6.0 to 30.0 wt.-%, even more
preferably of from 7.0 to 25.0 wt.-%, still more preferably of from 8.0 to 20 wt.-%, in each case based on the total weight of component A),
and/or
at least one pigment and/or filler as constituent a8), preferably in an amount in a range of from 5.0 to 30 wt.-%, more preferably of from 6.0 to 25.0 wt.-%, even more preferably of from 7.0 to 20.0 wt.-%, still more preferably of from 8.0 to 15 wt.-%, in each case based on the total weight of component A).

The term “pigment” is known to the skilled person, from DIN 55943 (date: October 2001), for example. A “pigment” in the sense of the present invention refers preferably to a constituent in powder or flake form which is substantially, preferably entirely, insoluble in the medium surrounding them, such as in one of the inventively used coating compositions, for example. Pigments are preferably colorants and/or substances which can be used as pigment on account of their magnetic, electrical and/or electromagnetic properties. Pigments differ from “fillers” preferably in their refractive index, which for pigments is ≥1.7. The term “filler” is known to the skilled person, from DIN 55943 (date: October 2001), for example. Pigments can be inorganic or organic.

Component A) of the primer coating system can optionally comprise one or more further constituents such in addition to or as alternative to the one or more constituents a6) to a8). Component A) may contain one or more commonly used additives depending on the desired application. For example, it may comprise at least one additive selected from the group consisting of reactive diluents, light stabilizers, antioxidants, deaerators, emulsifiers, slip additives, polymerization inhibitors, plasticizers, initiators for free-radical polymerizations, adhesion promoters, flow control agents, film-forming auxiliaries, flame retardants, corrosion inhibitors, siccatives, biocides, thickeners, and/or matting agents. They can be used in the known and customary proportions. Preferably, their content, based on the total weight of the coating composition obtained from mixing components A) and B) and optionally C) is 0.01 to 20.0 wt.-%, more preferably 0.05 to 15.0 wt.-%, particularly preferably 0.1 to 10.0% by weight, even more preferably from 0.1 to 7.5% by weight, especially from 0.1 to 5.0% by weight and most preferably from 0.1 to 2.5% by weight, in each case based on the total weight of the coating composition.

In particular, component A) of the primer coating system optionally comprises at least one levelling agent and/or dispersing agent (wetting agent) as additive as constituent a9). Preferably, a9) is (meth)acrylate polymer, which contains at least one kind of ether segment(s), preferably in a side chain, and/or at least one kind of siloxane units, preferably also in a side chain. Preferably, constituent a9) is present in component A)—in particular when also at least one optional constituent a5) is present—in a range of from 0.10 to 5.0 wt.-%, more preferably of from 0.50 to 4.0 wt.-%, still more preferably of from 0.80 to 3.5 wt.-%, to in each case based on the total weight of component A).

Component A) of the primer coating system may optionally comprise further polymer constituents different from a2) such as any type of polymers having functional groups, that are reactive towards NCO-groups, which can be used as constituent a10). Examples are (meth)acrylic polymers (different from a2), in particular (met) acrylic polymers, which are not modified with at least one chlorinated polyolefin), polyesters, polyurethanes, polyureas and polyethers as well as mixtures thereof.

### Component B)

Component B) comprises at least constituent b2) and optionally at least one constituent b1), which are different from one another, but may additionally comprise further optional constituents, which are each different from one another.

Preferably, component B) is free of any condensate a5), i.e., condensate a5) is if at all only present in component A) of the primer coating system.

Preferably, component B) of the primer coating system has a total solids content, which is >40 wt.-%, more preferably >45 wt.-%, even more preferably >50 wt.-%, still more preferably >55 wt.-%, in each based on the total weight of component B). The total solids content of component B) of the primer coating system s preferably in a range of from 45 to 100 wt.-%, more preferably of from 50 to <100 wt.-%, even more preferably of from 55 to <100 wt.-%, based in each case on the total weight of component B). The total solids content, in other words the non-volatile fraction, is determined in accordance with the method described hereinafter.

### Optional Constituent b1)

Optional constituent b1) is at least one organic solvent. Examples of such organic solvents include the ones already mentioned hereinbefore in connection with constituent a1). Component B) may comprise more than one organic solvent b1). The at least one organic solvent b1) may the identical to or different from the at least one organic solvent a1). If more than one organic solvent is used as a1) and/or b1) it may be that a1) and b1) are both partially identical and partially different.

Preferably, the amount of constituent b1) in component B) is in the range of from 0 or 5 to 50 wt.-%, more preferably of from 10 to 40 wt.-%, even more preferably of from 15 to 35 wt.-%, based in each case on the total weight of component B).

### Constituent b2)

Constituent b2) is an organic constituent bearing on average two or more NCO-groups. Preferably, constituent b2) bears on average more than two NCO-groups.

Preferably, the at least one organic constituent b2) present in component B) has an aliphatic or cycloaliphatic structure and/or a parent structure that is derived from an aliphatic or cycloaliphatic polyisocyanate by trimerization, dimerization, urethane formation, biuret formation, uretdione formation and/or allophanate formation. Trimers, i.e., isocyanurates, of IPDI (isophorone diisocyanate) and/or HDI (hexamethylene diisocyanate) are particularly preferred.

Suitable aliphatic polyisocyanates are preferably substituted or unsubstituted aliphatic polyisocyanates such as tetramethylene 1,4-diisocyanate, hexamethylene 1,6-diiso-cyanate, 2,2,4-trimethylhexane 1,6-diisocyanate, ethylene diisocyanate, dodecane 1,12-diisocyanate, and mixtures of the aforementioned polyisocyanates. Suitable polyisocyanate parent structures may be polyisocyanate prepolymers having urethane structural units which are obtained by reaction of polyols with a stoichiometric excess of aforementioned aliphatic polyisocyanates. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione

Suitable cycloaliphatic polyisocyanates are preferably substituted or unsubstituted cycloaliphatic polyisocyanates such as isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate and 4,4′-methylendicyclohexyl diisocyanate and mixtures of the aforementioned polyisocyanates. Suitable polyisocyanate parent structures may be polyisocyanates derived from a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be polyisocyanate prepolymers having urethane structural units which are obtained by reaction of polyols with a stoichiometric excess of aforementioned cycloaliphatic polyisocyanates. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

Preferably, constituent b2) does not contain any silane modified NCO-groups, i.e., none of its NCO-groups has been preferably reacted with any silane. Preferably, component B) as such does not comprise any NCO-group(s) containing constituent(s) that bear(s) any silane modified NCO-groups.

### Optional Constituent b3)

Optionally, component B) of the primer coating system comprises at least one optional constituent b3). Optional constituent b3) is an organosilane constituent being different from each of constituents b1) and b2) and bearing at least one hydrolyzable group X and preferably additionally at least one non-hydrolyzable organic residue R and/or T.

Optional constituent b3) is also different from each of the constituents a1) to a3) of component A). Preferably, constituent b3) is used as adhesion promoter.

Preferably, the at least one organosilane constituent b3) is a monosilane and has at least two, particularly preferably at least three hydrolyzable groups X, and/or is at least one bis(silane), which preferably has at least four, particularly preferably six hydrolyzable groups X.

Preferably, the at least one organosilane b3) is an organosilane of general formula (I) and/or (II)

Si(X)_{4-y}(R)_{y}, (I),

Si(X)_{3-z}(T)_{z}-(RA)-Si(X)_{3-z}(T)_{z} (II),
wherein in the case of general formula (I)
X is each independently a hydrolyzable group, preferably each independently selected from O—C1-4 alkyl,
the parameter y is an integer in the range from 1 to 3, but is at least 1, preferably exactly 1, and
R is a non-hydrolyzable organic residue, preferably aliphatic residue, which preferably has 1 to 10 carbon atoms, wherein at least one of residues R optionally comprises at least one functional group,
and wherein in the case of general formula (II)
X represents, in each case independently of one another, a hydrolyzable group and is preferably selected, in each case independently of one another, from O—C₁₋₄-alkyl,
RA represents a divalent non-hydrolyzable organic residue, preferably aliphatic residue, which preferably has 1 to 10 carbon atoms, which preferably contains no functional group,
the parameter z is in each case an integer in the range from 0 to 3, preferably in each case 0, and
T is a non-hydrolyzable organic residue, preferably aliphatic residue, which preferably has 1 to 10 carbon atoms, which is different from the residue RA, and which optionally comprises at least one functional group.

Examples of suitable functional groups are in particular thiol groups, amino groups, epoxide groups.

Examples of suitable organosilanes are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane, (3-glycidyloxypropyl)triethoxysilane, bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine.

### Optional Component C)

Optional component C) is a reducer component and comprises at least one organic solvent c1). Component C) is used for diluting the to-be-prepared coating composition and for this reason comprises at least one organic solvent c1) and preferably consists of the at least one organic solvent c1). Examples of such organic solvents include the ones already mentioned hereinbefore in connection with constituents a1) and b1). Component C) may comprise more than one organic solvent c1). The at least one organic solvent c1) may the identical to or different from the at least one organic solvent a1) and/or b1). If more than one organic solvent is used as a1) and/or b1) and/or c1) it may be that a1) and/or b1) and/or c1) are both partially identical and partially different.

### Layer L2 and Basecoat Composition

The second coating layer L2 is applied over the first coating layer L1, said layer L2 being obtainable from a basecoat composition (an intermediate coating composition).

Any type of basecoat composition can be used, e.g., a 1K- or 2K-basecoat composition, preferably a 1K-composition, which may be solventborne or aqueous and may contain coloring and/or effect pigments. Preferably, the basecoat composition comprises at least one film-forming binder, preferably at least one polymer, more preferably at least one polymer, which has functional groups that are reactive towards NCO-groups. Optionally, the basecoat composition may include at least one crosslinking agent, preferably selected from melamine formaldehyde resins and/or preferably blocked polyisocyanates, in particular in case the at least film-forming binder is an externally crosslinking polymer.

### Layer L3, Clearcoat Composition and Clearcoat System

The third coating layer L3 is applied over the second coating layer L2, said layer L3 being obtainable from a clearcoat composition.

Any type of clearcoat composition can be used, e.g., a 1K- or 2K-clearcoat composition, preferably a 2K-clearcoat composition, i.e., clearcoat composition which is in turn obtainable from a clearcoat system suitable for preparing a clearcoat composition, preferably comprising at least two components such as components D) and E) defined hereinafter and optionally at least one further component F) also defined hereinafter. Preferably, a solventborne clearcoat composition is used. Preferably, the clearcoat composition comprises at least one film-forming binder, preferably at least one polymer, more preferably at least one polymer, which has functional groups that are reactive towards NCO-groups. Optionally, the clearcoat composition may include at least one crosslinking agent, preferably selected from melamine formaldehyde resins and/or preferably blocked polyisocyanates, in particular in case the at least film-forming binder is an externally crosslinking polymer. However, in particular in case the clearcoat composition is obtainable from a clearcoat system, the at least one crosslinking agent may also be polyisocyanate having free NCO-groups.

Preferably, the clearcoat composition used for preparing layer L3, is obtainable from a clearcoat system such as 2K-clearcoat system comprising at least two components D) and E) and optionally at least one further component F), said components being different from one another and being separate from each other. The clearcoat system is a two- (2K-) or multi-component coating system. Separate from each other in this context means that components D) and E) and optionally F) of the coating system can be stored separately until they are mixed with each other in order to prepare a primer coating composition. In case the coating system is a two-component coating system, it preferably consists of components D) and E). Upon mixing of at least the two components D) and E) and applying the resulting composition to a surface of a substrate, a polyurethane or polyurethane-based coating film is preferably formed at least by reaction of the OH-groups of the at least one constituent d2) with the isocyanate groups of the at least one constituent e2) and optionally e3). These constituents will be defined hereinafter.

The preparation of the clearcoat composition can be carried out using customary and known preparation and mixing methods and mixing units, or using conventional dissolvers and/or stirrers.

Preferably, the clearcoat composition is a solventborne, i.e., an organic solvent(s) based, coating composition. The term “solventborne” has been already defined hereinbefore and applies here as well.

The clearcoat composition preferably includes an organic solvent(s) fraction of at most 65 wt.-%, more preferably of at most 60 wt.-%, even more preferably of at most 55 wt.-%, still more preferably of at most 50 wt.-%, yet more preferably of at most 48 wt.-%, in particular of at most 45 wt.-% or of at most 40 wt.-% or of at most 35 wt.-% or of at most 30 wt.-%, based in each case on the total weight of the coating composition. All conventional organic solvents known to those skilled in the art can be used as organic solvents, e.g., the solvents, which have been defined hereinbefore as constituents a1) and b1) and optionally c1). Examples of the organic solvents which can be used have been mentioned hereinbefore in connection with constituents a1) and b1) and c1).

Preferably, the clearcoat composition has a total solids content, which is >35 wt.-%, more preferably >40 wt.-%, even more preferably >45 wt.-%, still more preferably >50 wt.-%, based in each case on the total weight of the coating composition.

The total solids content of the clearcoat composition is preferably in a range of from >35 to 75 wt.-%, more preferably of from >40 to 70 wt.-%, even more preferably of from >45 to 65 wt.-%, still more preferably of from >48 to 60 wt.-%, based in each case on the total weight of the coating composition. The total solids content, in other words the non-volatile fraction, is determined in accordance with the method described hereinafter.

Preferably, the clearcoat composition is obtainable by mixing components D) and E) in a weight ratio (component D)/component E)) in a range of from 4:1 to 1:2. More preferably, mixing is performed in a weight ratio in the range of from 3:1 to 1:1, even more preferably in a weight ratio in the range of from 2:1 to 1:1, in particular in a weight ratio in the range of 1:1.

Preferably, both components D) and E) and also optional component F) of the coating system are free or essentially free of water. The same applies to the coating compositions obtainable therefrom. In the sense of the present invention the term “free of water” preferably means that no water at all is present. In the sense of the present invention the term “essentially free of water” preferably means that essentially no water is present. This means that at least no water is added on purpose to any of the inventively used components D) and E) and optionally F) and to the coating composition obtainable therefrom. It may, however, not be ruled out that remaining residues of water formed upon preparation of any of the constituents used for preparing the inventively used components D) and E) and optionally F) are present therein. Preferably, the amount of any water present in each of the component D) and E) and optionally F) is less than 1 wt.-%, more preferably less than 0.5 wt.-%, even more preferably less than 0.1 wt.-%, still more preferably less than 0.05 wt.-%, yet more preferably less than 0.01 wt.-%, in particular less than 0.005 wt.-% or less than 0.001 wt.-%, in each case based on the total weight of component D) or E) or optionally F). Preferably, both components D) and E) and also optional component F) of the coating system are solventborne, i.e., organic solvent(s)-based. Thus, preferably, the coating system is not a waterborne, i.e., not an aqueous coating system.

Preferably, both components D) and E) and optionally F) of the clear coating system are transparent, i.e., clear. Preferably, of course, also the clearcoat composition obtainable therefrom is transparent, i.e., clear. In particular, none of the component D) and E) and optionally F) of the coating system contains any pigments and/or fillers, in particular any color and/or effect imparting pigments and/or fillers. The same applies, of course, also preferably, to the clearcoat composition.

### Component D)

Component D) preferably comprises at least constituent d2) and optionally at least one constituent d1), which are different from one another, but may additionally comprise further optional constituents such as d3), d4) and/or d5), which are each different from one another, and also different from d1) and d2).

Preferably, component D) of the clearcoat system has a total solids content, which is >30 wt.-%, preferably >35 wt.-%, more preferably >40 wt.-%, even more preferably >45 wt.-%, based on the total weight of component D). The total solids content of component D) of the coating system is preferably in a range of from >35 to 60 wt.-%, more preferably of from 40 to 55.0 wt.-%, based in each case on the total weight of component D). The total solids content, in other words the non-volatile fraction, is determined in accordance with the method described hereinafter.

### Optional Constituent d1)

Optional constituent d1) is at least one organic solvent. Examples of such organic solvents include the ones already mentioned hereinbefore in connection with constituent a1) and b1) and c1). Component D) may comprise more than one organic solvents d1). The at least one organic solvent d1) may the identical to or different from the at least one organic solvent a1) and/or b1) and/or c1). If more than one organic solvent is used as a1) and/or b1) and/or c1) and/or d1) it may be that a1) and b1) and/or c1) and/or d1) are both partially identical and partially different.

### Constituent d2) and Optional Constituent d3)

Constituent d2) is at least one OH-functional (meth)acrylic polymer. Optional constituent d3) is also at least one OH-functional (meth)acrylic polymer, which, however, is different from d2). Preferably, both d2) and d3) are present in component D). The at least one OH-functional (meth)acrylic polymer d3) has a glass transition temperature (T_{g}) which is lower than the glass transition temperature (T_{g}) of the at least one OH-functional (meth)acrylic polymer d2). The amount of constituent d2) in component D) exceeds the amount of constituent d3), i.e., the (meth)acrylic polymer d2) having a higher T_{g} (higher than (meth)acrylic polymer d3)) is present in component D) in a higher amount than (meth)acrylic polymer d3) (if d3) is present). It has been found that using d2) and d3) in this manner in particular leads to an improved packaging stability of a resulting clearcoat prepared by making of component D). T_{g} is measured according to the method disclosed in the ‘method’ section.

Preferably, the at least one OH-functional (meth)acrylic polymer d2) present in component D) of the clearcoat system has a glass transition temperature (T_{g}) being in a range of from +10° C. to +75° C., preferably of from +15° C. to +70° C., more preferably of from +20° C. to +65° C., still more preferably of from +25° C. to +60° C., even more preferably of from +30° C. to +55° C., most preferably of from +35° C. or +40° C. to +50° C.

Preferably, the at least one OH-functional (meth)acrylic polymer d3) optionally present in component D) of the clearcoat system has a glass transition temperature (T_{g}) being in a range of from −70° C. to <+10° C., preferably of from −60° C. to +5° C., more preferably of from −50° C. to 0° C., still more preferably of from −45° C. to 0° C., even more preferably of from −40° C. to 0° C., yet more preferably of from −35° C. or −30° C. to −5° C., most preferably of from −25° C. or −5° C.

The OH-functional (meth)acrylic polymer d2) and d3) preferably each comprise on average two or more OH-groups. Preferably, each of OH-functional (meth)acrylic polymers d2) and d3) has an OH number of 30 to 400 mg KOH/g, more particularly between 100 and 300 KOH/g.

Preferably, each of constituents d2) and d3) have a weight average molecular weight M_{w}, measured by means of gel permeation chromatography (GPC) against a polystyrene standard, preferably between 800 and 100 000 g/mol, more particularly between 1000 and 75 000 g/mol.

The term (meth)acrylic polymer includes both homopolymers and copolymers in each case, but preferably means copolymers.

The term “(meth)acryl” or “(meth)acrylate” or (meth)acrylic” in the context of the present invention in each case comprises the meanings “methacryl” and/or “acryl” “methacrylic” and/or “acrylic” or “methacrylate” and/or “acrylate”. Therefore, a “(meth)acrylic copolymer” in general may be formed from only “acrylic monomers”, only “methacrylic monomers” or “acrylic and methacrylic monomers”. However, polymerizable monomers other than acrylic and/or methacrylic monomers as, e.g., styrene and the like may also be contained in a “(meth)acrylic copolymer”. In other words, a (meth)acrylic polymer may consist of only acrylic and/or methacrylic monomer units but does not have to. The notation “(meth)acrylate polymer or copolymer” or “(meth)acrylic polymer or copolymer” is intended to mean that the polymer/copolymer (polymer skeleton/backbone) is formed predominantly, i.e. preferably more than 50% or more than 75% of the monomer units used, from monomers having a (meth)acrylate group. In the preparation of a (meth)acrylic copolymer, preferably more than 50% or 75% of the monomers thus have a (meth)acrylate group. However, the use of further monomers as comonomers such as copolymerizable vinyl monomers, e.g., styrene, for its preparation is not excluded.

For introduction of OH-functionality, hydroxyl-containing monomers can be used, which include hydroxy alkyl esters of acrylic or methacrylic acid. Non-limiting examples of hydroxyl-functional monomers include hydroxyethyl (meth)acrylate, hydroxypropyl (meth)acrylates, hydroxybutyl-(meth)acrylates, hydroxyhexyl-(meth)acrylates, propylene glycol mono(meth)acrylate, 2,3-dihydroxypropyl (meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl-(meth)acrylates having branched or linear alkyl groups of up to about 10 carbons, and mixtures of these, where the term “(meth)acrylate” indicates either or both of the methacrylate and acrylate esters. Generally, at least about 5% by weight hydroxyl-functional monomer is preferably included in the polymer. Hydroxyl groups on a vinyl polymer such as an acrylic polymer can be generated by other means, such as, for example, the ring opening of a glycidyl group, for example from copolymerized glycidyl methacrylate, by an organic acid or an amine.

Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. Any of these methods may be used to prepare a useful hydroxyl-functional (meth)acrylic polymer.

Examples of suitable comonomers that may be used include, without limitation, a, B-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; a, B-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, α-methyl styrene, vinyl toluene, 2-vinyl pyrrolidone, and p-tert-butylstyrene.

The (meth)acrylic polymer may be prepared using conventional techniques, such as by heating the monomers in the presence of a polymerization initiating agent and optionally a chain transfer agent. The polymerization may be carried out in solution, for example. Typical initiators are organic peroxides such as dialkyl peroxides such as di-t-butyl peroxide, peroxyesters such as t-butyl peroxy 2-ethylhexanoate, and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol and the other thiol alcohols already mentioned, and dimeric alpha-methyl styrene.

The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes. Further details of addition polymerization generally and of polymerization of mixtures including (meth)acrylate monomers is readily available in the polymer art. The solvent or solvent mixture is generally heated to the reaction temperature and the monomers and initiator(s) are added at a controlled rate over a period of time, usually between 2 and 6 hours. A chain transfer agent or additional solvent may be fed in also at a controlled rate during this time. The temperature of the mixture is then maintained for a period of time to complete the reaction. Optionally, additional initiator may be added to ensure complete conversion.

Constituent d2) is preferably present in the component D) in an amount in the range of from 5.0 wt.-% to 85.0 wt.-%, based on the total weight of component (D). More preferably, constituent d2) is present in component D) in an amount in the range of from 10.0 wt.-% to 80.0 wt.-%, yet more preferably of from 15.0 wt.-% to 75.0 wt.-%, in each case based on the total weight of component D).

Optionally present constituent d3) is preferably present in the component D) in an amount in the range of from 5.0 wt.-% to 85.0 wt.-%, based on the total weight of component (D). More preferably, constituent d3) is present in component D) in an amount in the range of from 10.0 wt.-% to 80.0 wt.-%, yet more preferably of from 15.0 wt.-% to 75.0 wt.-%, in each case based on the total weight of component D).

### Optional Constituent d4)

Optional constituent d4) is at least one catalyst d4), which is preferably suitable for crosslinking of NCO-groups, and which is preferably selected from organotin catalysts. Catalyst d4) may be identical to or different from catalyst a3). Preferably, catalysts d4) and a3) are identical.

Component D) may comprise at least one further organometal catalyst besides catalyst d4) such as, e.g., organobismuth catalysts. However, preferably, if such at least one further organometal catalyst like an organobismuth catalyst is additionally present in component D), its amount is less than the amount of catalyst d4). More preferably, however, component D) does not comprise any other organometal catalysts besides catalyst d4) and in particular does not comprise any organobismuth catalysts.

Preferably, the at least one catalyst d4) suitable for crosslinking of NCO-groups, in particular of constituent e2) of component E), is present in component D) of the clearcoat system in an amount in a range of from 0.001 to 3.00 wt.-%, preferably of from 0.01 to 2.50 wt.-%, more preferably of from 0.05 to 2.00 wt.-%, still more preferably of from 0.10 to 1.50 wt.-%, yet more preferably of from 0.20 to 1.25 wt.-%, most preferably of from 0.30 to 1.00 wt.-%, based on the total weight of component D).

Catalyst d4) is preferably selected from organotin catalysts. Examples of organotin catalysts are DOTL (dioctyltin dilaurate) and DBTL (dibutyltin dilaurate). DOTL is particularly preferred.

### Optional Constituent d5)

Preferably, component D) of the clearcoat system further comprises at least one catalyst d5), which is preferably suitable for crosslinking of Si-containing functional groups, catalyst d5) being different from each of constituents d1) to d4). Catalyst d5) may be identical to or different from catalyst a4) and a4a).

Preferably, the at least one catalyst d5) is suitable for crosslinking of Si-containing functional groups being present in constituent e2) of component E).

Preferably, component D) of the clearcoat system comprises the at least one catalyst d5) in an amount in a range of from 0.01 to 6.00 wt.-%, preferably of from 0.10 to 5.50 wt.-%, more preferably of from 0.40 to 5.00 wt.-%, still more preferably of from 0.70 to 4.50 wt.-%, yet more preferably of from 1.00 to 4.00 wt.-%, most preferably of from 1.10 to 3.75 wt.-%, based on the total weight of component D).

Preferably, the at least one catalyst d5) is a phosphorus-containing catalyst and/or a phosphorus-containing and nitrogen-containing catalyst. More than one such as two different catalysts can be used as catalyst d5).

Examples of suitable phosphorus-containing catalysts are substituted phosphonic diesters and diphosphonic diesters, preferably selected from the group consisting of acyclic phosphonic diesters, cyclic phosphonic diesters, acyclic diphosphonic diesters and cyclic diphosphonic diesters. More particularly, however, use as at least one catalyst d5) is made of substituted phosphoric monoesters and phosphoric diesters, preferably selected from the group consisting of acyclic phosphoric diesters and monoesters and cyclic phosphoric diesters and monoesters, which may be in each case amine adducts, e.g., of phosphoric monoesters and diesters.

Examples of such amine adducts are corresponding amine-blocked phosphoric esters, and, of these, more particularly, amine-blocked ethylhexyl phosphates and amine-blocked phenyl phosphates, very preferably amine-blocked bis(2-ethylhexyl) phosphate. Examples of amines with which the phosphoric esters are blocked are, in particular, tertiary amines, examples being bicyclic amines, such as diazabicyclooctane (DABCO), diazabicyclononene (DBN), diazabicycloundecene (DBU), dimethyldodecylamine or triethylamine, for example. Particularly preferred for blocking the phosphoric esters is the use of tertiary amines which ensure high activity of the catalyst under the curing conditions. Certain amine-blocked phosphoric acid catalysts are also available commercially (e.g., Nacure types from King Industries such as Nacure® 4167).

Preferably, the at least one catalyst d5) is selected from phosphorus-containing organic constituents, more preferably from acyclic phosphoric diesters, acyclic phosphoric monoesters, cyclic phosphoric diesters and cyclic phosphoric monoesters, wherein each of the aforementioned phosphoric diesters and monoesters can optionally be present in form of an adduct with at least one amine (i.e., blocked with at least one amine), which preferably are, however, not blocked with any amine, preferably, at least one tertiary amine, even more preferably, wherein at least two catalysts are present as the at least one catalyst d5), which are both selected from acyclic phosphoric diesters, acyclic phosphoric monoesters, cyclic phosphoric diesters and cyclic phosphoric monoesters, but wherein at least one of these at least two catalysts is present in the form of its amine adduct and the other one of these at least two catalysts is not present as amine adduct (i.e., in an unblocked form).

Preferably, at least two kinds of catalysts d5) are present, one catalyst being not present in any form of an amine adduct such as 2-ethylhexylacid phosphate, preferably in an amount in a range of from 0.05 to 3.5 wt.-%, more preferably of from 0.10 to 3.0 wt.-%, still more preferably of from 0.50 to 2.0 wt.-% or to 1.5 wt.-%, and one catalyst being present in form of an amine adduct, preferably in an amount in a range of from 1.0 to 4.0 wt.-%, more preferably of from 1.0 to 3.0 wt.-%. Preferably, the amount of the catalyst being present in form of an amine adduct exceeds the amount of the catalyst being present not in form of an amine adduct.

Preferably, at least 2-ethylhexylacid phosphate is used as at least one catalyst d5), in particular as at least one catalyst d5), which is not present in the form of an amine adduct, i.e., not in any amine blocked form. The term “2-ethylhexylacid phosphate” comprises both monoethylhexyl acid phosphate and diethylhexyl acid phosphate.

### Further Constituents

Component D) can optionally comprise one or more further constituents. Component D) may contain one or more commonly used additives depending on the desired application. For example, it may comprise at least one additive selected from the group consisting of reactive diluents, light stabilizers, antioxidants, deaerators, emulsifiers, slip additives, polymerization inhibitors, plasticizers, initiators for free-radical polymerizations, adhesion promoters, flow control agents, film-forming auxiliaries, flame retardants, corrosion inhibitors, siccatives, biocides, thickeners, wetting agents, levelling agents and/or matting agents. They can be used in the known and customary proportions. Preferably, their content, based on the total weight of the coating composition obtained from mixing components D) and E) and optionally F) is 0.01 to 20.0 wt.-%, more preferably 0.05 to 15.0 wt.-%, particularly preferably 0.1 to 10.0% by weight, even more preferably from 0.1 to 7.5% by weight, especially from 0.1 to 5.0% by weight and most preferably from 0.1 to 2.5% by weight, in each case based on the total weight of the coating composition.

Component D) may contain further one or more further (meth)acrylic polymers being different from both d2) and d3), which may be OH-functional as well but do not necessarily have to. Component D) may comprise one or more further film forming polymers suitable as binder constituent such as polyesters and/or polyurethanes. Suitable polyesters are described for example in EP-A-0 994 117 and EP-A-1 273 640. Polyurethane polyols are prepared preferably by reaction of polyester polyol prepolymers with suitable di- and/or polyisocyanates and are described for example in EP-A-1 273 640.

### Component E)

Component E) preferably comprises at least two constituent e2) and optionally at least constituent e1), which are different from one another, but may additionally comprise further optional constituents, which are also different from one another and from e1) and e2).

Preferably, component E) of the clearcoat system has a total solids content, which is >40 wt.-%, more preferably >45 wt.-%, even more preferably >50 wt.-%, still more preferably >55 wt.-%, in each based on the total weight of component E). The total solids content of component E) of the clearcoat system is preferably in a range of from 45 to 100 wt.-%, more preferably of from 50 to <100 wt.-%, even more preferably of from 55 to <100 wt.-%, based in each case on the total weight of component E). The total solids content, in other words the non-volatile fraction, is determined in accordance with the method described hereinafter.

### Optional Constituent e1)

Optional constituent e1) is at least one organic solvent. Examples of such organic solvents include the ones already mentioned hereinbefore in connection with constituent a1) and b1) and c1) and d1. Component E) may comprise more than one organic solvents e1). The at least one organic solvent e1) may the identical to or different from the at least one organic solvent a1) and/or b1) and/or c1) and/or d1). If more than one organic solvent is used as a1) and/or b1) and/or c1) and/or d1) and/or e1) it may be that a1) and b1) and/or c1) and/or d1) and/or e1) are both partially identical and partially different.

### Constituent e2)

Constituent e2) is an organic constituent bearing on average two or more NCO-groups, wherein preferably, at least a part of the NCO-groups has been reacted with at least one organosilane prior to incorporation of constituent e2) into component E).

Examples of constituents e2) are, e.g., disclosed in WO 2009/077181 A1, WO 2010/139375 A1, WO 2010/063332 A1, WO 2014/086530 A1 and WO 2014/086529 A1. Constituent e2) may be identical to or different from constituent b2). In particular when e2) has underwent an at least partial silanization as outlined above, e2) is different from b2).

Preferably, the at least one constituent e2) of component E) of the clearcoat system bears at least one structural unit of the formula (I)

—NR—(X—SiR″ₓ(OR′)₃₋ₓ) (I),
and/or, preferably and, at least one structural unit of the formula (II)

—N(X—SiR″ₓ(OR′)₃₋ₓ)ₙ(X′—SiR″_{y}(OR′)_{3-y})ₘ (II),
wherein:
   R=hydrogen, alkyl, cycloalkyl, aryl or aralkyl, it being possible for the carbon chain to be interrupted by nonadjacent oxygen, sulfur or NR^{a} groups,
   where R^{a}=alkyl, cycloalkyl, aryl or aralkyl,
   each R′=independently of one another hydrogen, alkyl or cycloalkyl, it being possible for the carbon chain to be interrupted by nonadjacent oxygen, sulfur or NR^{a} groups, preferably wherein each R′=ethyl and/or methyl,
   each X,X′=independently of one another linear and/or branched alkylene or cycloalkylene radical having 1 to 20 carbon atoms, preferably wherein each X,X′=alkylene radical having 1 to 4 carbon atoms,
   each R″=independently of one another alkyl, cycloalkyl, aryl or aralkyl, it being possible for the carbon chain to be interrupted by nonadjacent oxygen, sulfur or NR^{a} groups, preferably wherein each R″=alkyl radical, more particularly having 1 to 6 C atoms,
   n=parameter of 0 to 2, m=parameter of 0 to 2, m+n=2, and x, y=parameter of 0 to 2.

The respective preferred alkoxy radicals (OR′) may be identical or different, but what is decisive for the structure of the radicals is the extent to which they influence the reactivity of the hydrolysable silane groups. Preferably R′ is an alkyl radical, more particularly having 1 to 6 carbon atoms. Particularly preferred are radicals R′ which increase the reactivity of the silane groups, i.e. represent good leaving groups. Accordingly a methoxy radical is preferred over an ethoxy radical, which in turn is preferred over a propoxy radical. With particular preference, therefore, R′=ethyl and/or methyl, more particularly methyl. The reactivity of organofunctional silanes may also be influenced considerably, furthermore, by the lengths of the spacers X, X′ between silane functionality and organic functional group which serves for reaction with the constituent to be modified. Examples thereof that may be mentioned include the “alpha” silanes, which are obtainable from the company Wacker, and in which there is a methylene group, instead of the propylene group present in the case of “gamma” silanes, between Si atom and functional group.

In constituent e2) preferably, between 10 and 80 mol-%, preferably between 15 and 70 mol-%, more preferably between 20 and 50 mol-% and still more preferably between 25 and 40 mol-% of the isocyanate groups originally present have undergone reaction with the at least one organosilane, preferably to form structural units (I) and/or (II), more preferably to form structural units (I) and (II).

Moreover, preference is given to constituent e2), in which the total amount of structural units (I) is between 3 and 90 mole-%, more preferably between 5 and 70 mole-%, based in each case on the entirety of the structural units (I) plus (II), and the total amount of structural units (II) is between 97 and 10 mole-%, more preferably between 95 and 30 mole-%, based in each case on the entirety of the structural units (I) plus (II).

The at least one organic constituent e2) bearing on average two or more NCO-groups, which serves-before reaction with at the least one silane—as the parent structure for the constituent e2) represent at this stage before reaction with the at least one silane a di- and/or polyisocyanate. Preferably, said at least one di- and/or polyisocyanate is an aromatic, aliphatic, cycloaliphatic and/or heterocyclic di- and/or polyisocyanate, in particular aliphatic and acylic.

The at least one organic constituent e2) preferably has a cycloaliphatic parent structure and/or a parent structure that is derived from a cycloaliphatic polyisocyanate by trimerization, dimerization, urethane formation, biuret formation, uretdione formation and/or allophanate formation, wherein constituent e2) has at least one structural unit of the formula (I) and/or (II). Alternatively or additionally, the at least one organic constituent e2) preferably has an acyclic aliphatic parent structure and/or a parent structure that is derived from an acyclic aliphatic polyisocyanate by trimerization, dimerization, urethane formation, biuret formation, uretdione formation and/or allophanate formation, wherein constituent e2) has at least one structural unit of the formula (I) and/or (II).

Most preferably, the at least one organic constituent e2) has an acyclic aliphatic parent structure and/or a parent structure that is derived from an acyclic aliphatic polyisocyanate by trimerization, dimerization, urethane formation, biuret formation, uretdione formation and/or allophanate formation, wherein constituent e2) has at least one structural unit of the formula (I) and/or (II). Trimers, i.e., isocyanurates, are particularly preferred.

The acyclic aliphatic polyisocyanates serving as parent structures are preferably substituted or unsubstituted aliphatic polyisocyanates that are known per se. Examples are tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates.

Additionally preferred polyisocyanate parent structures are the polyisocyanates derived from such an acyclic aliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may also be polyisocyanate prepolymers having urethane structural units which are obtained by reaction of polyols with a stoichiometric excess of aforementioned acyclic aliphatic polyisocyanates. Polyisocyanate prepolymers of this kind are described for example in U.S. Pat. No. 4,598,131. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione.

The cycloaliphatic polyisocyanates used as parent structures are preferably substituted or unsubstituted cycloaliphatic polyisocyanates which are known per se. Examples of preferred polyisocyanates are isophorone diisocyanate, cyclobutane 1,3-diisocyanate, cyclohexane 1,3-diisocyanate, cyclohexane 1,4-diisocyanate, diisocyanates, hexahydrotoluene 2,4-diisocyanate, methylcyclohexyl hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylendicyclohexyl diisocyanate (e.g. Desmodur® W from Bayer AG) and mixtures of the aforementioned polyisocyanates. Additionally preferred polyisocyanate parent structures are the polyisocyanates derived from such a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be ppolyisocyanate prepolymers having urethane structural units which are obtained by reaction of polyols with a stoichiometric excess of aforementioned cycloaliphatic polyisocyanates. Such polyisocyanate prepolymers are described for example in U.S. Pat. No. 4,598,131. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

The at least one silane used for reaction with at least one organic constituent e2) bearing on average two or more NCO-groups prior to incorporation of e2) into component E) is preferably
at least one compound of the formula (Ia)

H—NR—(X—SiR″ₓ(OR′)₃₋ₓ) (Ia),
and/or at least one compound of the formula (IIa)

HN(X—SiR″ₓ(OR′)₃₋ₓ)ₙ(X′—SiR″_{y}(OR′)_{3-y})ₘ (IIa),
where the substituents have the definitions stated above including the preferred definitions.

Preferred compounds (Ia) are aminoalkyltrialkoxysilanes, such as, preferably, 2-aminoethyltrimethoxysilane, 2-aminoethyltriethoxysilane, 3-aminopropyltrimethoxysilane, 3-aminopropyltriethoxysilane, 4-amino-butyltrimethoxysilane, 4-aminobutyltriethoxysilane. Particularly preferred compounds (Ia) are N-(2-(trimethoxysilyl)ethyl)alkylamines, N-(3-(tri-methoxysilyl) propyl)alkylamines, N-(4-(trimethoxysilyl)butyl) alkylamines, N-(2-(triethoxysilyl)ethyl)alkylamines, N-(3-(triethoxysilyl) propyl)alkylamines and/or N-(4-(triethoxysilyl)butyl)alkylamines. Especially preferred is N-(3-(trimethoxysilyl) propyl)butylamine. Aminosilanes of these kinds are available for example under the brand name DYNASYLAN® from DEGUSSA or Silquest® from OSI.

Preferred compounds (Ila) are bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine. Especially preferred is bis(3-propyltrimethoxysilyl)amine. Aminosilanes of these kinds are available for example under the brand name DYNASYLAN® from DEGUSSA or Silquest® from OSI.

### Optional Constituent e3)

Optionally present constituent e3) is an organic constituent bearing on average two or more NCO-groups, which is different from e2). In particular, when constituent e2) bears on average two or more NCO-groups, wherein at least a part of these NCO-groups has been reacted with at least one organosilane prior to incorporation of constituent e2) into component E), optionally present constituent e3) does not contain any silane modified NCO-groups.

Optionally present constituent e3) may be identical to or different from constituent b2). Preferably, constituent e3) bears on average more than two NCO-groups.

Preferably, the at least one organic constituent e3) optionally present in component E) has an aliphatic or cycloaliphatic structure and/or a parent structure that is derived from an aliphatic or cycloaliphatic polyisocyanate by trimerization, dimerization, urethane formation, biuret formation, uretdione formation and/or allophanate formation. Trimers, i.e., isocyanurates, of IPDI (isophorone diisocyanate) and/or HDI (hexamethylene diisocyanate) are particularly preferred.

Suitable aliphatic polyisocyanates are preferably substituted or unsubstituted aliphatic polyisocyanates such as tetramethylene 1,4-diisocyanate, hexamethylene 1,6-diiso-cyanate, 2,2,4-trimethylhexane 1,6-diisocyanate, ethylene diisocyanate, dodecane 1,12-diisocyanate, and mixtures of the aforementioned polyisocyanates. Suitable polyisocyanate parent structures may be polyisocyanate prepolymers having urethane structural units which are obtained by reaction of polyols with a stoichiometric excess of aforementioned aliphatic polyisocyanates. Particularly preferred polyisocyanate parent structures are hexamethylene diisocyanate and/or its biuret dimer and/or allophanate dimer and/or isocyanurate trimer and/or its uretdione, and also mixtures of the stated polyisocyanate parent structures. Especially preferred polyisocyanate parent structures are hexamethylene diisocyanate and/or its isocyanurate trimer, optionally together with its uretdione.

Suitable cycloaliphatic polyisocyanates are preferably substituted or unsubstituted cycloaliphatic polyisocyanates such as isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate and 4,4′-methylendicyclohexyl diisocyanate and mixtures of the aforementioned polyisocyanates. Suitable polyisocyanate parent structures may be polyisocyanates derived from a cycloaliphatic polyisocyanate by trimerization, dimerization, urethane formation, biuret formation, uretdione formation and/or allophanate formation, more particularly the biuret dimer and/or the allophanate dimer and/or the isocyanurate trimer. The polyisocyanate parent structures may be polyisocyanate prepolymers having urethane structural units which are obtained by reaction of polyols with a stoichiometric excess of aforementioned cycloaliphatic polyisocyanates. Particularly preferred cycloaliphatic polyisocyanates are isophorone diisocyanate and 4,4′-methylenedicyclohexyl diisocyanate and/or the biuret dimers thereof and/or the allophanate dimers thereof and/or the isocyanurate trimers thereof.

### Optional Component F)

Optional component F) is a reducer component and comprises at least one organic solvent f1). Component F) is used for diluting the to-be-prepared coating composition and for this reason comprises at least one organic solvent f1) and preferably consists of the at least one organic solvent f1). Examples of such organic solvents include the ones already mentioned hereinbefore in connection with constituents a1) and b1) and c1) and d1) and e1). Component F) may comprise more than one organic solvent f1). The at least one organic solvent f1) may the identical to or different from the at least one organic solvent a1) and/or b1) and/or c1) and/or d1) and/or e1). If more than one organic solvent is used as a1) and/or b1) and/or c1) and/or d1) and/or e1) and/or f1) it may be that a1) and/or b1) and/or c1) and/or d1) and/or e1) and/or f1) are both partially identical and partially different.

### Use

A further subject-matter of the present invention is a use of the multilayer coating system as defined hereinbefore and hereinafter comprising at least three coatings layers L1, L2 and L3 being different from one another for application on substrates selected from metal and plastic substrates, preferably selected from plastic substrates, more preferably selected from fiber reinforced plastic substrates, even more preferably selected from carbon fiber reinforced plastic substrates.

All preferred embodiments described above herein in connection with the inventive multilayer coating system and in each case the preferred embodiments thereof, are also preferred embodiments of the aforementioned use.

### Method of Preparing a Multilayer Coating System

A further subject-matter of the present invention is a method of preparing a multilayer coating system on at least one surface of an optionally pre-coated substrate comprising at least steps 1) to 3) and optionally 4). Preferably, this method is used for preparing the inventive multilayer coating system.

All preferred embodiments described above herein in connection with the inventive multilayer coating system and the inventive use and in each case the preferred embodiments thereof, are also preferred embodiments of the aforementioned method of preparing a multilayer coating system.

The method comprises at least steps (1), (2), (3) and optionally (4). The method may, however, comprise further additional optional steps.

Preferably, each of step 1) to 3) is performed via a spray application.

The first, second, and third coating film formed on the optionally pre-coated substrate by performing steps 1), 2), and 3) are at this stage preferably each an uncured coating film. Thus, preferably both the first and the second and the third coating compositions are applied wet-on-wet.

### Step 1)

Step 1) relates to applying a first coating composition at least partially to at least one surface of an optionally pre-coated substrate and forming a first coating film on said surface, wherein the first coating composition is an inventively used primer coating composition.

Preferably, the inventive method further comprises a step 1a), which is carried out after step 1) and before step 2). In said step 1a) the first coating film obtained after step 1) is flashed-off before applying the second coating composition in step 2) preferably for a period of 1 to 20 minutes, more preferably for a period of 1.5 to 15 minutes, still more preferably for a period of 2 to 12 minutes, yet more preferably for a period of 5 to 11 minutes, most preferably for a period of 8 to 10 minutes. Preferably, step 1a) is performed at a temperature not exceeding 40° C., more preferably at a temperature in the range of from 18 to 30° C.

The term “flashing off” in the sense of the present invention means a drying, wherein at least some of the solvents and/or water are evaporated from the coating film (i.e., from the primer coating layer being formed), before any curing is carried out. No curing is performed by the flashing-off.

### Step 2)

Step 2) relates to applying at least one basecoat composition as at least one second coating composition to the first coating film present on the substrate obtained after step 1), preferably prior to curing the first coating film, and forming a second coating film, which is preferably adjacent to the first coating film.

Preferably, the method further comprises a step 2a), which is carried out after step 2) and before step 3). In said step 2a) the second coating film obtained after step 2) is flashed-off before applying the third coating composition in step 3), preferably for a period of 1 to 20 minutes, more preferably for a period of 1.5 to 15 minutes, still more preferably for a period of 2 to 12 minutes, yet more preferably for a period of 5 to 11 minutes, most preferably for a period of 8 to 10 minutes. Preferably, step 2a) is performed at a temperature not exceeding 40° C., more preferably at a temperature in the range of from 18 to 30° C.

### Step 3)

Step 3) relates to applying a clearcoat composition as third coating composition to the second coating film present on the substrate obtained after step 2), preferably prior to curing the second coating film and forming a third coating film, which is preferably adjacent to the second coating film and which preferably is the outermost coating film of the formed multilayer coating system.

Preferably, the method further comprises a step 3a), which is carried out after step 3) and before step 4). In said step 3a) the third coating film obtained after step 3) is flashed-off before performing curing step 4), preferably for a period of 1 to 20 minutes, more preferably for a period of 3 to 15 minutes, in particular for a period of 7 to 12 minutes. Preferably, step 3a) is performed at a temperature not exceeding 40° C., more preferably at a temperature in the range of from 18 to 30° C.

### Step 4)

In optional step 4) first, second and third coating films are jointly cured, i.e., are cured together simultaneously. Preferably, step 4) is performed. The cured third coating film preferably represents the outermost layer of the formed multilayer coating system obtained after step 4).

Each resulting cured coating film represents a coating layer. Thus, after performing step 4) a first, second and third coating layer is formed on the optionally pre-coated substrate, with the third layer being preferably the outermost layer of the formed multilayer coating system. A first layer L1 is obtainable from the first coating film, a second layer L2 from the second coating film and a third layer L3 from the third coating film.

Preferably, step 4) is performed at a temperature in a range of from 30 to 180° C., more preferably in a range of from 35 to 170° C., even more preferably in a range of from 40 to 140° C., still more preferably in a range of from 40 to 130° C., in each case preferably for a period of 5 to 45 minutes, more preferably for a period of 10 to 40 minutes, in particular for a period of 12.5 to 35 minutes, most preferably for a period of 15 to 30 minutes. Most preferably, in particular, when a plastic substrate or fiber reinforced plastic substrate is used, step 4) is performed at a temperature not exceeding 80° C., preferably not exceeding 70° C., more preferably not exceeding 60° C., even more preferably not exceeding 55° C. Temperature is in each case substrate temperature, which is preferably measured with a thermocouple.

Preferably, the cured primer film (layer L1) obtained after having performed step 4) has a dry film thickness in a range of from 10 to 35 μm. Preferably, the cured basecoat film (layer L2) obtained after having performed step 4) has a dry film thickness in a range of from 12 to 35 μm. Preferably, the cured topcoat, in particular clearcoat, film (layer L3) obtained after having performed step 4) has a dry film thickness in a range of from 30 to 60 μm.

### Kit-of-Parts

A further subject-matter of the present invention is a kit-of-parts comprising separated from one another at least
an inventively used primer coating system as defined hereinbefore and hereinafter comprising the at least two components A) and B) and optionally at least one further component C) and
a clearcoat composition, preferably a 1K-clearcoat composition, or a 2K-clearcoat system suitable for preparing a clearcoat composition, preferably comprising at least two components D) and E) and optionally at least one further component F) as defined hereinafter.

The kit-of-parts may optionally further comprise a basecoat composition or a basecoat coating system for providing a basecoat composition, but preferably consists of the both the inventively used primer coating system and a clearcoat composition or a clearcoat system suitable for preparing a clearcoat composition.

All preferred embodiments described above herein in connection with the inventive multilayer coating system and the aforementioned use and method of preparing a multilayer coating system, and in each case the preferred embodiments thereof, are also preferred embodiments of the aforementioned kit-of-parts.

### Methods

### 1. Humidity Exposure

Humidity exposure is determined according to the high humidity test (96 h) of GMW 14729 (4^{th} edition, August 2020).

### 2. Tape Adhesion

Tape adhesion is determined according to the tape adhesion test of GMW 14829 (4th edition, June 2017) (method A described therein).

### 3. Appearance

Appearance is determined by measuring LW (long wave) and short wave (SW) values of the coatings via BYK wave scan meter 2. In order to meet criteria of “Class A Appearance”, a coating should preferably have LW values≤10 and SW values≤20.

### 4. Resistance to Pressure Water-Jetting

To evaluate the resistance of a coating to pressure water-jetting (steam jet) the method according to VW PV 1503B is used.

### 5. Scratch Resistance

Dry scratch resistance is determined by using an Atlas M38BB Electric Crockmeter (10 cycles with 9-micron paper). A 2″×2″ piece of 9-micron 3M 281Q WETODRY™ polishing paper is affixed to the cylindrical acrylic finger of the moveable arm of the Crockmeter with a wire clamp. Coated 4″×12″ steel test panels are secured below the moveable arm with a magnet. After ensuring the abrasive is smooth to the panel surface, ten cycles of back and forth (or double rubs) are carried out. The same procedure is repeated a second time on the same panel with a new piece of 3M paper after sliding the panel to an untested area. Upon completion of the test, the 20° gloss is measured for both tested areas and an untested area of the panel using a micro-TRI-gloss gloss meter from BYK. The percent gloss retention (% GR) is calculated by taking the average of the gloss of the two tested areas and dividing by the gloss of the untested area.

### 6. Thermal Shock

The thermal shock is determined according to the test of GMW 15919 (3^{rd} edition, March 2019).

### 7. Packaging Stability

Packaging stability is determined using the imprint test for impression resistance in line with DIN EN ISO 3678:1995-04. Round test weights made of metal 500 g (diameter 5 cm/height 3 cm). Each sample pieces (size of the test specimens: approx. 6×6 cm) are from the packaging materials (tissue paper/packaging bags/packaging towels) which are usually used by ASP customers to pack and pack coated plastic parts. After the oven to be used has dried, the test panel is immediately placed in a standard climate control room (23° C./50% RH (relative air humidity)) and the respective test points are identified. After a waiting time of 10-15 minutes, the first test point is filled with the first sample of the packaging medium and immediately loaded with a test weight. Additional samples of the respective packaging medium are placed on the marked points on the test plate after an aging time of 1 h, 2 h, 4 h and 24 h from the furnace removal and are also loaded with further test weights. The test weights and the sample of the packaging medium are removed 24 hours after the start of the individual load tests.

### Rating Criteria:

| Density | | Size |
|---|---|---|
| ISO | ASTM | ISO |
| 0 | None | |
| 1 | Scarce | 1 × 10 magnification |
| 2 | Few | visible |
| 3 | Medium | up to 0.5 mm 0.5-5 mm |
| 4 | Medium-High | >5 mm |
| 5 | High | |

### 8. Glass Transition Temperature

The glass transition temperature is measured by means of DSC measurements in accordance with DIN EN ISO 11357-2 (2019-03)

### 9. Dynamic Light Scattering (DLS)

The average particle size of optional constituent a5) (and the silica starting material used) is determined by Dynamic light scattering (DLS) method following ISO 21501-4 standard. Measurement was done using a Beckman coulter instrument (Model: Delsa Nano C particle analyzer; Software: Delsa Nano 2.31). The sample solution was prepared approximately 0.01% in filtered distilled water prior to check.

### EXAMPLES

The following examples further illustrate the invention but are not to be construed as limiting its scope. ‘Pbw’ means parts by weight. If not defined otherwise, ‘parts’ means ‘parts by weight’.

### 1. Preparation of 2K Primer Coating Systems and Coating Material Compositions Obtainable Therefrom

1.1 The “A”-components of inventively used 2K primer coating systems IPC1 and IPC2 as well as of a comparatively used 2K primer coating system CPC1 have been prepared by mixing the constituents listed in Table 1.1 in this order.

TABLE 1.1
“A”-component

| | IPC1, | CPC1, | IPC2, |
|---|---|---|---|
| Constituent | amount [pbw] | amount [pbw] | amount [pbw] |
| Pigment paste P1 | 6.04 | 6.04 | 5.39 |
| Cyclohexanone | 0.93 | 0.93 | 0.83 |
| Xylene | 2.89 | 2.89 | 2.58 |
| (Mixed isomers) | | | |
| Isopropanol | 0.23 | 0.23 | 0.21 |
| NMP | 1.73 | 1.73 | 1.54 |
| AS1 | 0.24 | 0.24 | 0.22 |
| Epoxy resin | 2.55 | 2.55 | 2.28 |
| CPO | 12.08 | 12.08 | 10.78 |
| Pigment paste P2 | 0.01 | 0.01 | 0.01 |
| Pigment paste P3 | 0.01 | 0.01 | 0.01 |
| Pigment paste P4 | 0.02 | 0.02 | 0.02 |
| Pigment paste P5 | 0.02 | 0.02 | 0.02 |
| Xylene | 0.94 | 0.94 | 0.84 |
| (Mixed isomers) | | | |
| ACL | 27.70 | — | 24.74 |
| AS2 | 31.03 | 31.03 | 27.70 |
| Methyl propyl ketone | 13.30 | 13.30 | 11.87 |
| Nacure ® 4167 | 0.17 | — | 0.15 |
| TIB KAT ® 216 | 0.02 | — | 0.01 |
| 2-Ethylhexylacid | 0.08 | — | 0.07 |
| phosphate | | | |
| Silica-silane | — | — | 8.93 |
| condensate | | | |
| BYK 3565 | — | — | 1.79 |

Pigment paste P1 contains 60 wt.-% of a titanium dioxide pigment and further comprises an alkyl resin. Pigment paste P2 contains 6 wt.-% of a carbon black pigment and further comprises an alkyl resin. Pigment paste P3 contains 10 wt.-% of an organic blue pigment and further comprises an alkyl resin. Pigment paste P4 contains 47 wt.-% of an inorganic yellow pigment and further comprises an alkyl resin. Nacure® 4167 is a commercially available amine neutralized phosphate catalyst. TIB KAT® 216 is a liquid tin catalyst based on dioctyl tin compounds. BYK 3565 is a commercially available surface-active additive. AS1 and AS2 are both commercially available aromatic solvent mixtures, which are different from one another. NMP is N-Methylpyrrolidone. CPO is a commercially available solution of a chlorinated polyolefin (solid content 19.8 wt.-%). ACL is Acrydic® CL-408, a commercially available solventborne acrylic resin, which is OH-functional, and which has been modified with a chlorinated polypropylene (solid content 44.0 to 46 wt.-%). The epoxy resin is a reaction product of bisphenol A and DGEBA, a bisphenol A diglycidyl ether, and has an epoxy equivalent weight of 465 to 500.

The silica-silane condensate used is a MTMS-silica condensate and was prepared prior to its incorporation into the “A”-component of IPC2 by reacting methyl trimethoxysilane (MTMS) with a commercially available nano-silica dispersion (LUDOX® AS-40). For preparing the silica-silane condensate, MTMS (0.45 moles) was mixed with acetic acid (1.45 wt.-%) and the mixture was cooled to 0° C. Then, water (9.7 wt.-%; 0.54 moles) was added as well as LUDOX® AS-40 (24.5 wt.-%; 0.97 moles, wherein 0.16 moles thereof correspond to silica and the remaining parts corresponds to water also present within this product). Thus, the molar ratio of MTMS to silica to was 0.45:0.16, i.e., about 2.8. The resulting mixture was then stirred at room temperature for 12 to 16 h. Then, acetic acid and TBAA (tetrabutylammonium acetate) as catalyst were added (3.13 wt.-% acetic acid and 0.17 wt.-% TBAA) and the mixture was stirred for 2 to 3 h maintaining a pH of 5.1. The resulting mixture (solid content 43 wt.-%) was then diluted with isopropyl alcohol (1:1 by weight) and then used in this form as silica-silane condensate for preparing the “A”-component of IPC2.

1.2 The “B”-component for use in the 2K primer coating systems IPC1, IPC2 and CPC1 has been prepared by mixing the constituents listed in Table 1.2 in this order.

TABLE 1.2
“B”-component

| Constituent | Amount [wt.-%] |
|---|---|
| Butyl acetate | 20.02 |
| Dynasylan ® 1189 | 1.5 |
| Dynasylan ® 1124 | 26.9 |
| Desmodur ® N3600 | 51.58 |
| Σ | 100.00 |

Desmodur® N3600 is a commercially available aliphatic polyisocyanate (HDI trimer). Dynasylan® 1189 is N-(3-(Trimethoxysilyl) propyl)butylamine. Dynasylan® 1124 is Bis(trimethoxysilylpropyl)amine.

1.3 Primer coating material compositions were prepared from mixing the “A”-component with the “B”-component of the primer coating system IPC1 in a weight ratio of 12.89:1 with each other (“A” to “B”) or in case of the primer coating system CPC1 in a weight ratio of 12.89:1 with each other (“A” to “B”) or in case of the primer coating system IPC2 in a weight ratio of 14.44:1 with each other (“A” to “B”).

The mixing ratios were calculated and chosen such that an excess of about 10-12 wt.-% of polyisocyanates originating from component “B” is still present in the resulting compositions in order to also cure a subsequently to be applied basecoat film via NCO-migration when applied on top of a primer coating film being obtainable from applying the primer coating material composition onto a surface of a substrate.

2. Preparation of a 2K Clearcoat System and a Clearcoat Material Composition Obtainable Therefrom 2.1 The “A”-component of a 2K clearcoat system ICC1 has been prepared by mixing the constituents listed in Table 2.1 in this order.

TABLE 2.1
“A”-component of ICC1

| Constituent | ICC1, amount [pbw] |
|---|---|
| Acrylic resin 1 | 6.78 |
| Acrylic resin 2 | 14.00 |
| Acrylic resin 3 | 34.11 |
| AS3 | 17.27 |
| Butyl acetate | 15.40 |
| Additive 1 | 2.28 |
| Additive 2 | 0.99 |
| Additive 3 | 0.05 |
| Additive 4 | 0.03 |
| Nacure ® 4167 | 2.18 |
| Catalyst 1 | 0.74 |
| 2-Ethylhexylacid phosphate | 1.19 |
| Butyl acetate | 2.98 |
| Butyl acetate | 1.99 |
| Σ | 100.00 |

Catalyst 1 is a commercially available catalyst, namely TIB KAT® 216 (DOTL), which is a liquid tin catalyst based on dioctyl tin compounds. Additive 1 is a commercially available liquid hydroxyphenyl-triazine (HPT) UV absorber. Additive 2 is a commercially available liquid hindered amine light stabilizer. Additive 3 is a commercially available silicone containing surface additive. Additive 4 is a commercially available defoamer. Nacure® 4167 has already been described hereinbefore. AS3 is a commercially available aromatic solvent mixture, which is different from AS1 and AS2 identified hereinbefore. Acrylic resin 1 is a solution of an OH-functional (meth)acrylic resin having a T_{g} of −15° C. prepared from N-butyl methacrylate, styrene 4-hydroxybutyl acrylate and 2-hydroxyethyl acrylate (solid content: 65 wt). Acrylic resin 2 is a dispersion of an OH-functional (meth)acrylic resin having a T_{g} of +34° C. prepared from 3-hydroxypropyl methacrylate, 2-etyhylhexyl (meth)acrylate and cyclohexyl (meth)acrylate (solid content: 67.5 wt.-%). Acrylic resin 3 is a dispersion of an OH-functional (meth)acrylic resin having a T_{g} of +46° C. prepared from n-Butyl methacrylate, styrene, cyclohexyl methacrylate, 2-hydroxypropyl methacrylate and 2-hydroxyethyl methacrylate (solid content: 60.0 wt.-%).

2.2 The “B”-component of 2K clearcoat system ICC1 is a polyisocyanate. Part of the NCO-groups of said polyisocyanate (the product Desmodur® N3600 has been used as starting material) has been silanized by making use of two different organosilanes, namely Dynasylan® 1189 and Dynasylan® 1124) prior to its use in/as component “B”. Desmodur® N3600 is a commercially available aliphatic polyisocyanate (HDI trimer). Dynasylan® 1189 is N-(3-(Trimethoxysilyl) propyl)butylamine. Dynasylan® 1124 is Bis(trimethoxysilylpropyl)amine. The “B” component is commercially available (“B”-component of iGloss® refinish).

2.3 Clearcoat material compositions were prepared from mixing the “A”-component with the “B”-component of the clearcoat system ICC1 in a weight ratio of 1:1 with each other (“A” to “B”).

### 3. Preparation of Multilayer Coating Systems

3.1 A number of multilayer coating systems have been obtained by making use of the aforementioned primer and clearcoat material compositions as well as by making use of one of different basecoat (intermediate coat) material compositions in each case as it will be outlined hereinafter.

3.2 Multilayer coating systems comprising a primer layer obtained from IPC1 or IPC2, a basecoat layer and a clearcoat layer obtained from ICC1 (all inventive)

A carbon fiber (C-fiber) reinforced plastic substrate was used as a substrate, namely the product Ultramid® XA3418, which is a carbon fiber reinforced polyamide. A primer coating material composition obtained from primer coating system IPC1 or IPC2 prepared as described in item 1.3 was applied to a surface of the substrate to form a primer film and flashed for 10 minutes at ambient conditions (room temperature). One of basecoat material composition SBBC1 to SBBC4 (each being solventborne) or WBBC1 to WBBC4 (each being waterborne) was then sprayed onto the primer film to form a basecoat film and flashed for 10 minutes at ambient conditions (room temperature). In case of the waterborne basecoat material compositions (WBBC) a further flash off for 5 minutes at an elevated temperature of 140° F. (60° C.) was performed. Then, a clearcoat material composition obtained from clearcoat system ICC1 prepared as described in item 2.3 was applied onto the basecoat film and flashed for 10 minutes at ambient conditions (room temperature) and then all films were simultaneously baked for 30 minutes at 122° F. (50° C.) substrate temperature.

The dry film thickness of each primer layer obtained after curing from each primer film was in a range of from 0.5 to 1 mil (12.7 μm to 25.4 μm). The dry film thickness of each basecoat layer obtained after curing from each basecoat film was in a range of from 0.6 to 1 mil (15.24 μm to 25.4 μm) and the dry film thickness of each clearcoat layer obtained after curing from each clearcoat film was in a range of from 1.9 to 2.1 mil (48.26 μm to 53.34 μm).

SBBC1 to SBBC4 are high solids solventborne differently pigmented basecoat material compositions. The following commercial products have been used:
SBBC1: Shadow Black
SBBC2: Ingot Silver
SBBC3: Oxford White
SBBC4: Hot Pepper Red.

Spray viscosity of SBBC2 to SBBC4 was adjusted to around 35 cP before application using a suitable solvent such as n-butyl acetate. Spray viscosity of SBBC1 was adjusted to around 55 cP before application using a suitable solvent such as n-butyl acetate.

WBBC1 to WBBC4 are high solids differently pigmented waterborne basecoat material compositions. The following commercial products have been used:
WBBC1: Exterior Black
WBBC2: Switchblade Silver
WBBC3: Abalone White
WBBC4: Caught Red Handed.

Spray viscosity of WBBC1 to SBBC4 was adjusted to around 90 to 95 cP before application.

3.3 Further multilayer coating systems comprising a primer layer obtained from IPC1, a basecoat layer and a clearcoat layer obtained from ICC1 (all inventive)

Further multilayer coating systems were prepared in the same manner as described in item 3.2 using the same type of coating material compositions. The only difference is that besides Ultramid® XA3418 three further different substrates have been used, namely the following substrates S1 to S4, which are:
S1: Steel (CG 800)
S2: Ultramid® XA3418 (as in the series described in item 3.2)
S3: Polypropylene, reinforced with carbon fibers (20 wt.-%) (CB201SY)
S4: TPO (thermoplastic olefin).

3.4 Comparative experiments

3.4.1 A further multilayer coating system was prepared in the same manner as described in item 3.2 using SBBC1 as basecoat and comprising a clearcoat layer obtained from ICC1. However, instead of IPC1 a commercial internally crosslinking 1K primer coating material composition has been used, namely Med Gray AdPro, which does not contain any polyisocyanates and also not ACL (Acrydic® CL-408, a commercially available solventborne acrylic resin modified with chlorinated polypropylene, wherein the modified resin is OH-functional). Instead, the commercial 1K primer coating material composition used comprised an epoxy resin as well as an alkyd resin. This multilayer coating system is referred to as comparative example CE1.

3.4.2 A further multilayer coating system was prepared in the same manner as described in item 3.2 using SBBC1 as basecoat and comprising a clearcoat layer obtained from ICC1. However, instead of IPC1, comparative 2K primer coating system CPC1 has been used. This multilayer coating system is referred to as comparative example CE2.

3.4.3 A further multilayer coating system was prepared in the same manner as described in item 3.2 using SBBC1 as basecoat and comprising a clearcoat layer obtained from ICC1. However, instead of IPC1, the commercial 2K clearcoat product Evergloss® 905 has been used as primer coating material composition. This multilayer coating system is referred to as comparative example CE3.

3.4.4 A further multilayer coating system was prepared in the same manner as described in item 3.2 using SBBC1 as basecoat and comprising a clearcoat layer obtained from ICC1. However, instead of IPC1, a commercially available 2K clearcoat system (refinish iGloss®) has been used as primer coating material composition. This multilayer coating system is referred to as comparative example CE4.

3.4.5 A further multilayer coating system was prepared in the same manner as described in item 3.2 using SBBC1 as basecoat. However, for preparing the clearcoat layer not ICC1 but the commercial 2K clearcoat product Evergloss® 905 has been used. Further, for preparing the primer layer instead of IPC1 the commercial 1K primer Med Gray AdPro has been used. Moreover, a baking temperature of 80° C. (not 50° C.) was used. This multilayer coating system is referred to as comparative example CE5.

3.4.6 A further multilayer coating system was prepared in the same manner as described in item 3.2 using SBBC1 as basecoat. For preparing the primer layer IPC1 has been used. However, for preparing the clearcoat layer not ICC1 has been used. Instead, three different clearcoat systems have been used, which each comprised the “A”-component of clearcoat system ICC1, but each contained a different “B” component. In each case, the different “B” component did not contain any silanized polyisocyanate, but rather only non-silanized polyisocyanates. In case of the preparation of multilayer coating system according to comparative example CE6 only Desmodur® N3600 has been used as “B” component of the clearcoat system used. In case of the preparation of multilayer coating system according to comparative example CE7 the “B” component of the commercially available clearcoat system Evergloss® 905 has been used. In case of the preparation of multilayer coating system according to comparative example CE8 the “B” component of the commercially available clearcoat system 2K4® has been used.

4. Properties of the Substrates Coated with the Multilayer Coating Systems

4.1 In Tables 4.1a and 4.1b and 4.1c a number of properties measured and/or determined according to the methods defined in the “methods” section are summarized, which have been obtained for the multilayer coating systems present on a carbon fiber reinforced plastic substrate prepared as described hereinbefore in item 3.2.

TABLE 4.1a
Properties of multilayer coating system with
primer layer obtained from IPC1, a basecoat
layer, and a clearcoat layer obtained from ICC1

| Type of | | | Initial tape | Tape adhesion, | Resistance |
|---|---|---|---|---|---|
| basecoat | | | adhesion | after 5 days | to pressure |
| material | Appear- | Appear- | before | storage after | water- |
| composition | ance, | ance, | humidity | humidity | jetting |
| used | LW | SW | exposure | exposure | (steam jet) |
| WBBC1 | 4.1 | 12.9 | 5B | 5B | Pass |
| WBBC2 | 5.7 | 18.6 | 5B | 5B | Pass |
| WBBC3 | 4.6 | 20.0 | 5B | 5B | Pass |
| WBBC4 | 5.0 | 18.7 | 5B | 5B | Pass |
| SBBC1 | 5.6 | 18.3 | 5B | 5B | Pass |
| SBBC2 | 5.4 | 20.0 | 5B | 5B | Pass |
| SBBC4 | 5.1 | 16.9 | 5B | 5B | Pass |

TABLE 4.1b
Properties (continued) of multilayer coating system
with primer layer obtained from IPC1, a basecoat
layer, and a clearcoat layer obtained from ICC1

| Type of | | | |
|---|---|---|---|
| basecoat | | | |
| material | Packaging | | Scratch |
| composition | stability | Thermal | resistance |
| used | (imprint) | shock | [% GR] |
| WBBC1 | Pass | Pass | 70.6 |
| WBBC2 | Pass | Pass | 70.1 |
| WBBC3 | Pass | Pass | 72.0 |
| WBBC4 | Pass | Pass | 68.2 |
| SBBC1 | Pass | Pass | 76.4 |
| SBBC2 | Pass | Pass | 79.9 |
| SBBC3 | Pass | Pass | 75.4 |
| SBBC4 | Pass | Pass | 72.1 |

TABLE 4.1c
Properties of multilayer coating system with
primer layer obtained from IPC2, a basecoat
layer, and a clearcoat layer obtained from ICC1

| Type of | | | Initial tape | Tape adhesion, |
|---|---|---|---|---|
| basecoat | | | adhesion | after 5 days |
| material | | | before | storage after |
| composition | Appearance, | Appearance, | humidity | humidity |
| used | LW | SW | exposure | exposure |
| WBBC1 | 5.5 | 15.3 | 5B | 5B |
| WBBC2 | 4.4 | 17.7 | 5B | 5B |
| WBBC3 | 5.7 | 18.9 | 5B | 5B |
| WBBC4 | 6.2 | 19.0 | 5B | 5B |
| SBBC1 | 5.4 | 18.5 | 5B | 5B |
| SBBC2 | 4.3 | 17.2 | 5B | 5B |
| SBBC3 | 5.5 | 19.5 | 5B | 5B |
| SBBC4 | 4.7 | 15.2 | 5B | 5B |

4.2 Further, an accelerated weathering study was performed following SAE J2527 & ASTM 7869 methods using the multilayer coating systems present on the different substrates as described in item 3.3. All multilayer coating systems on all substrates passed the tests.

4.3 In Table 4.2 a number of properties measured and/or determined according to the methods defined in the “methods” section are summarized, which have been obtained for the comparative multilayer coating system CE1 prepared as described hereinbefore in item 3.4.1, for the comparative multilayer coating system CE2 prepared as described hereinbefore in item 3.4.2, for the comparative multilayer coating system CE3 prepared as described hereinbefore in item 3.4.3, and for the comparative multilayer coating system CE4 prepared as described hereinbefore in item 3.4.4.

TABLE 4.2
Properties of multilayer coating system with a primer layer, a basecoat layer
obtained from SBBC1, and a clearcoat layer obtained from ICC1 (comparative)

| | | | | Tape adhesion, | Resistance | |
|---|---|---|---|---|---|---|
| | | | Initial tape | after 5 days | to pressure | |
| | | | adhesion before | storage after | water-jetting | Thermal |
| | Appearance, LW | Appearance, SW | humidity exposure | humidity exposure | (steam jet) | shock |
| CE1 | 5.8 | 16.7 | Borderline | Fail | Fail | Fail |
| | | | (black strip) | | | |
| CE2 | 6.2 | 26.5 | Borderline | Fail | Fail | Fail |
| | | | (black strip) | | | |
| CE3 | 6.0 | 24.0 | Pass | Fail | Fail | Fail |
| CE4 | 7.0 | 34.3 | Pass | Fail | Fail | Fail |

Each of CE1 to CE4 show inferior tape adhesion after humidity exposure, steam jet and thermal shock properties. The “black strip” that comes out when using the tape adhesion test suggests an insufficient basecoat cure. It has been found in this regard that using an excess of isocyanate in the clearcoat does not improving the basecoat curing. In addition, each of CE2 to CE4 have SW values too high to meet the class A requirements regarding appearance.

4.4 In Table 4.3 a number of properties measured and/or determined according to the methods defined in the “methods” section are summarized, which have been obtained for the comparative multilayer coating system CE5 prepared as described hereinbefore in item 3.4.5.

TABLE 4.3
Properties of multilayer coating system with a primer layer, a basecoat layer obtained
from SBBC1, and a clearcoat layer obtained from Evergloss ® 905 (comparative)

| | | | | Tape adhesion, | Resistance | |
|---|---|---|---|---|---|---|
| | | | Initial tape | after 5 days | to pressure | |
| | | | adhesion before | storage after | water-jetting | Thermal |
| | Appearance, LW | Appearance, SW | humidity exposure | humidity exposure | (steam jet) | shock |
| CE5 | 17.5 | 43.5 | Pass | Pass | Pass | Pass |

CE5 has both LW and SW values too high to meet the class A requirements regarding appearance.

4.5 In Table 4.5 packaging stability data measured according to the method defined in the “methods” section and rated according to the criteria identified therein are summarized, which have been obtained for the inventive multilayer system with a primer layer obtained from IPC1, a basecoat layer obtained from SBBC1, and a clearcoat layer obtained from ICC1.

TABLE 4.5
Packaging stability

| | Packaging | Packaging | Packaging |
|---|---|---|---|
| Multilayer coating | stability after | stability after | stability after |
| system | 1 h | 4 h | 24 h |
| IPC1/SBBC1/ICC1 | medium | few | none |

4.6 In Table 4.6 a number of properties measured and/or determined according to the methods defined in the “methods” section are summarized, which have been obtained for the comparative multilayer coating systems CE6, CE7 and CE8 prepared as described hereinbefore in item 3.4.6.

TABLE 4.6
Properties of multilayer coating systems CE6, CE7 and CE8 (comparative)

| | | | | Tape adhesion, | Resistance | |
|---|---|---|---|---|---|---|
| | | | Initial tape | after 5 days | to pressure | |
| | | | adhesion before | storage after | water-jetting | Thermal |
| | Appearance, LW | Appearance, SW | humidity exposure | humidity exposure | (steam jet) | shock |
| CE6 | 6.9 | 30.7 | Pass | Pass | Fail | Fail |
| CE7 | 7.2 | 25.6 | Fail | Fail | Fail | Fail |
| CE8 | 8.7 | 38.0 | Fail | Fail | Fail | Fail |

CE6 to CE8 have a poor appearance and show inferior tape adhesion after humidity exposure (CE7 and CE8), steam jet and thermal shock properties (each of CE6 to CE8).

1. A multilayer coating system being present on an optionally pre-coated substrate and comprising at least three coatings layers L1, L2 and L3 being different from one another,
a first coating layer L1 applied over at least a portion of an optionally pre-coated substrate, said layer L1 being obtained from a primer coating composition, which in turn is obtained from a primer coating system comprising at least two components A) and B) and optionally at least one further component C), said components being different from one another and being separate from each other,
wherein component A) comprises at least constituent a2) and optionally at least constituent a1), which are different from one another,
optionally at least one organic solvent a1), and
at least one polymer a2), which contains functional groups, that are reactive towards NCO-groups, wherein polymer a2) is a (meth)acrylic polymer, which has been modified with at least one chlorinated polyolefin,
wherein component B) comprises at least two constituent b2) and optionally at least constituent b1), which are different from one another,
optionally at least one organic solvent b1), and
at least one organic constituent b2) bearing on average two or more NCO-groups, and
wherein optional component C) is a reducer component and comprises at least one organic solvent c1),
a second coating layer L2 applied over the first coating layer L1, said layer L2 being obtained from a basecoat composition, and
a third coating layer L3 applied over the second coating layer L2, said layer L3 being obtained from a clearcoat composition,
wherein layer L3 is obtained from a 2K-clearcoat composition, which in turn is obtained from a clearcoat system comprising at least two components D) and E) and optionally at least one further component F), said components being different from one another and being separate from each other,
wherein component D) comprises at least constituent d2) and optionally at least constituent d1), which are different from one another,
optionally at least one organic solvent d1), and
at least one OH-functional (meth)acrylic polymer d2),
wherein component E) comprises at least constituent e2) and optionally at least constituent e1), which are different from one another,
optionally at least one organic solvent e1), and
at least one organic constituent e2) bearing on average two or more NCO-groups, wherein at least a part of these NCO-groups has been reacted with at least one organosilane prior to incorporation of constituent e2) into component E), and
wherein optional component F) is a reducer component and comprises at least one organic solvent f1).

2. The multilayer coating system according to claim 1, wherein the at least three coatings layers L1, L2 and L3 are positioned adjacently to each other and/or wherein the third coating layer L3 is the outermost coating layer of the multilayer coating system.

3. The multilayer coating system according to claim 1, wherein the substrate is selected from the group consisting of metal and plastic substrates.

4. The multilayer coating system according to claim 1, wherein the multilayer coating system displays LW (long wave) values≤10 and SW (short wave) values≤20.

5. The multilayer coating system according to claim 1, wherein polymer a2) is contained in component A) of the primer coating system in an amount in a range of from 5.0 to 50.0 wt.-%, based on the total weight of component A).

6. The multilayer coating system according to claim 1, wherein component A) of the primer coating system further comprises at least one of constituents a3) and a4), which are different from one another and different from each of constituents a1) and a2),
constituent a3) being a catalyst a3) suitable for crosslinking of NCO-groups, and
constituent a4) being a catalyst a4), which is selected from the group consisting of phosphorus-containing organic constituents.

7. The multilayer coating system according to claim 1, wherein component A) of the primer coating system further comprises at least one constituent a5) different from any of constituents a1) to a4) and which is a condensation product, which in turn is obtained at least by reaction of (i) at least one organosilane bearing at least one hydrolyzable group with (ii) at least one kind of silica, based on the total weight of component A).

8. The multilayer coating system according to claim 1, wherein component A) of the primer coating system further comprises at least one levelling agent and/or dispersing agent as an additive constituent a9), which is different from each of constituents a1) to a4).

9. The multilayer coating system according to claim 1, wherein component D) of the clearcoat system comprises at least two OH-functional (meth)acrylic polymers d2) and d3), which are different from one another, wherein the at least one OH-functional (meth)acrylic polymer d3) has a glass transition temperature (T_{g}) lower than the glass transition temperature (T_{g}) of the at least one OH-functional (meth)acrylic polymer d2).

10. The multilayer coating system according to claim 1, wherein component D) of the clearcoat system further comprises at least one of constituents d4) and d5), which are different from one another and different from each of constituents d1) to d3),
constituent d4) being at least one catalyst d4) suitable for crosslinking of NCO-groups,
constituent d5) being at least one catalyst d5), which is selected from the group consisting of phosphorus-containing organic constituents.

11. The multilayer coating system according to claim 1, wherein at least one constituent e2) of component E) of the clearcoat system bears at least one structural unit of the formula (I)
—NR—(X—SiR″ₓ(OR′)₃₋ₓ) (I),
and/or, at least one structural unit of the formula (II)
—N(X—SiR″ₓ(OR′)₃₋ₓ)ₙ(X′—SiR″_{y}(OR′)_{3-y})ₘ (II),
wherein:
R=hydrogen, alkyl, cycloalkyl, aryl or aralkyl, it being possible for the carbon chain to be interrupted by nonadjacent oxygen, sulfur or NR^{a} groups, where R^{a}=alkyl, cycloalkyl, aryl or aralkyl,
each R′=independently of one another hydrogen, alkyl or cycloalkyl, it being possible for the carbon chain to be interrupted by nonadjacent oxygen, sulfur or NR^{a} groups, preferably wherein each R′=ethyl and/or methyl,
each X,X′=independently of one another linear and/or branched alkylene or cycloalkylene radical having 1 to 20 carbon atoms,
each R″=independently of one another alkyl, cycloalkyl, aryl or aralkyl, it being possible for the carbon chain to be interrupted by nonadjacent oxygen, sulfur or NR^{a} groups,
n=parameter of 0 to 2, m=parameter of 0 to 2, m+n=2, and x, y=parameter of 0 to 2,
and/or wherein between 10 and 80 mol-% of the isocyanate groups originally present in at least one constituent e2) have undergone reaction with the at least one organosilane,
and/or wherein component E) further comprises at least one organic constituent e3) bearing on average two or more NCO-groups, which is different from constituent e2) and does not contain any silane modified NCO-groups and which is identical to or different from constituent b2).

12. A method of using the multilayer coating system according to claim 1, the method comprising using the multilayer coating system for application on substrates selected from the group consisting of metal and plastic substrates.

13. A method of preparing a multilayer coating system on at least one surface of an optionally pre-coated substrate comprising at least steps 1) to 3) and optionally 4),
1) applying a first coating composition at least partially to at least one surface of an optionally pre-coated substrate and forming a first coating film on said surface,
wherein the first coating composition is a primer coating composition according to claim 1,
2) applying at least one basecoat composition as at least one second coating composition to the first coating film present on the substrate obtained after step 1), and forming a second coating film, and
3) applying a clearcoat composition as third coating composition to the second coating film present on the substrate obtained after step 2),
wherein the third coating composition is the clearcoat composition, and
4) optionally jointly curing the first, second and third coating films to obtain a multilayer coating system comprising cured first, second, and third coating layers.

14. A multilayer coating system obtained by the method according to claim 13.

15. A kit-of-parts comprising separated from one another at least
a primer coating system comprising the at least two components A) and B) and optionally the at least one further component C) according to claim 1 and
a 2K-clearcoat system suitable for preparing a clearcoat composition, comprising the at least two components D) and E) and optionally the at least one further component F).

16. The multilayer coating system according to claim 1, wherein the substrate is a plastic substrate.

17. The multilayer coating system according to claim 1, wherein polymer a2) is contained in component A) of the primer coating system in an amount in a range from 10.0 to 45.0 wt.-%, based on the total weight of component A).

18. The multilayer coating system according to claim 1, wherein component A) of the primer coating system further comprises at both of constituents a3) and a4).

19. The multilayer coating system according to claim 7, wherein the molar ratio of the at least one organosilane and the at least one kind of silica used for preparing said condensation product a5) to each other is in a range of from 10:1 to 1:1 and/or wherein the at least one condensation product a5) is present in component A) in an amount in a range of from 1.0 to 25.0 wt.-%, based on the total weight of component A).

20. The multilayer coating system according to claim 1, wherein component A) of the primer coating system further comprises at least one levelling agent and/or dispersing agent as an additive constituent a9), which is different from each of constituents a1) to a4), which is a (meth)acrylate polymer.
